(19) United States
(12) Patent Application Publication
(10) Pub. No.: US 2024/0328230 A1
(43) Pub. Date: Oct. 3, 2024

(54) ACTUATOR SYSTEMS AND METHODS FOR VEHICLE CLOSURE PANELS

(71) Applicant: MAGNA CLOSURES INC., Newmarket (CA)

(72) Inventors: Joseph OSMIALOWSKI, Newmarket (CA); Dan COSMIN, Newmarket (CA); Roman PAERSCHKE, Newmarket (CA); Sebastian PRENGEL, Newmarket (CA); Martin DANNEMANN, Newmarket (CA)

(21) Appl. No.: 18/625,148

(22) Filed: Apr. 2, 2024

Related U.S. Application Data
(60) Provisional application No. 63/456,597, filed on Apr. 3, 2023.
(60) Provisional application No. 63/464,232, filed on May 5, 2023.

(51) Int. Cl. E05F 15/616; E05F 1/10

(52) U.S. Cl. CPC E05F 15/616; E05F 1/10; E05Y 2201/41; E05Y 2201/416; E05Y 2201/422; E05Y 2900/548

(57) ABSTRACT

An actuator system for a closure panel of a vehicle and method of operation are provided. The system includes a biasing member adapted to apply a biasing member force to the closure panel. The system also includes an actuator assembly comprising an actuator housing. The actuator assembly also includes a motor disposed in the actuator housing and configured to rotate a motor shaft operably coupled to an extensible member coupled to one of a body and the closure panel for opening or closing the closure panel. The system also includes an actuator controller configured to control the motor to output an adjusted force based on the biasing member force to move the closure panel.

### CROSS-REFERENCE TO RELATED APPLICATIONS

This utility application claims the benefit of U.S. Provisional Application No. 63/456,591 filed Apr. 3, 2023 and U.S. Provisional Application No. 63/464,232 filed May 5, 2023. The entire disclosure of the above applications are incorporated herein by reference.

### FIELD

The present disclosure relates to actuator systems for closure panels or panels of a vehicle. More specifically, the present disclosure relates to an actuator system for a lift gate of a vehicle.

### BACKGROUND

This section provides background information related to the present disclosure which is not necessarily prior art.

Vehicles are equipped with a variety of closure panels, such as a lift gate, which may be driven between an open position (position 2) and a closed position (position 1) using an electric drive system. Vehicle closure panels can employ struts to assist the vehicle operator to open the closure panel, close the closure panel, and help maintain the closure panel in the open position or in an intermediate hold position (third position hold). Typically, the struts can be biased and can also be automatically controlled via an electric motor of the electric drive system. These struts are important in terms of both convenience and safety, because without them, vehicle operators can risk injury when entering or exiting the vehicle via the closure panel, e.g., when loading or unloading the vehicle.

Therefore, it is desirable to employ motorized struts with vehicle closure panels for ease of operation. However, available space is typically limited in the vicinity of strut mounting on the vehicle frame. Current motorized strut designs utilize motors and/or motor controllers mounted on the exterior of the strut housing which may increase or alter the strut outer envelope, which is problematic due to space constraints. Further, the motorized struts may utilize internal counterbalance mechanisms, employing springs, for example, which can lead to difficulties in controlling such motorized struts.

In view of the above, there remains a need to develop actuator systems and methods of operation which address and overcome limitations and drawbacks associated with known actuator systems as well as to provide increased convenience and enhanced operational capabilities.

### SUMMARY

This section provides a general summary of the disclosure, and is not a comprehensive disclosure of its full scope or all of its features.

It is an object of the present disclosure to provide an actuator system for a closure panel of a vehicle. The system includes a biasing member adapted to apply a biasing member force to the closure panel. The system also includes an actuator assembly comprising an actuator housing and a motor disposed in the actuator housing. The motor is configured to rotate a motor shaft operably coupled to an extensible member coupled to one of a body and the closure panel for opening or closing the closure panel. The system additionally includes an actuator controller configured to control the motor to output an adjusted force based on the biasing member force to move the closure panel.

In another aspect, the closure panel is a lift gate and determining a stop position of the lift gate by the actuator controller includes determining no motion of the lift gate by a user.

In another aspect, the biasing member fully supports the lift gate at a steady state position without assistance from the motor.

According to another aspect, a method of operating an actuator system of a vehicle is also provided. The method includes the step of determining a position of a closure panel. The method continues with the step of determining a force that negates an effect of a counterbalance mechanism acting on the closure panel. The method also includes the step of adjusting a target compensation force to be provided to a motor of an actuator assembly using the force that negates the effect of the counterbalance mechanism acting on the closure panel.

In another aspect, a sag of the lift gate occurs in response to the motor not providing additional lifting force of the lift gate in the unbalanced position.

In another aspect, a thermal timer used is a predetermined time period calculated using an estimated temperature of the motor based on a detected current draw to the motor during a hold operation of the motor and an ambient temperature in which the vehicle is located.

In another aspect, the counterbalance mechanism comprises a counterbalance spring adapted to apply a biasing member force to the closure panel.

According to a further aspect, an actuator system for a closure panel of a vehicle is provided. The system includes an actuator assembly comprising an actuator housing. The actuator assembly also includes a power spring at least partially disposed in the actuator housing and adapted to apply a biasing member force to the closure panel. In addition, the actuator assembly includes a motor disposed in the actuator housing and configured to rotate a motor shaft operably coupled to an extensible member coupled to one of a body and the closure panel for opening or closing the closure panel. The system also includes an actuator controller configured to control the motor and output an adjusted force based on the biasing member force to move the closure panel. The actuator controller includes a closed loop current feedback motor control system configured to supply the motor with a drive current. The actuator controller also includes a haptic control algorithm configured to determine a target torque the motor, controlled by the closed loop current feedback motor control system, applies to the closure panel. The actuator controller additionally includes a drive unit configured to convert the target torque from the haptic control algorithm into a target current for input into the closed loop current feedback motor control system.

In another aspect, the actuator system further includes a current sensor configured to detect a sensed current flowing in the motor and communicate the sensed current to the haptic control algorithm.

In another aspect, the actuator system further includes an accelerometer configured to sense motion of the closure panel and output an acceleration signal to at least one of the drive unit or the haptic control algorithm.

In another aspect, the actuator system further includes closure panel position sensors configured to indicate a position of the closure panel to the drive unit.

In another aspect, the closure panel position sensors include at least one closure panel feedback sensor for determining at least one of the position and a speed and an attitude of the closure panel and a motor sensor coupled to the motor and configured to provide a motor position of the motor or a speed of the motor.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of a vehicle with a closure panel assembly, according to aspects of the disclosure;

FIG. 2 is a further embodiment of the vehicle of FIG. 1, according to aspects of the disclosure;

FIG. 3 is an example biasing member as a closure panel strut of the closure panel assembly of FIG. 1, according to aspects of the disclosure;

FIG. 4 is a further embodiment of the biasing member of FIG. 3 as an electromechanical biasing member with an electronic motor assembly according to aspects of the disclosure;

FIG. 5 illustrates a block diagram of the power closure panel actuation system, according to aspects of the disclosure;

FIG. 6 illustrates another block diagram of the power closure panel actuation system for moving the closure panel in an automatic mode, according to aspects of the disclosure;

FIGS. 7 and 7A illustrates the power closure panel actuation system shown as part of a vehicle system architecture, according to aspects of the disclosure;

FIG. 8 illustrates another block diagram of the power closure panel actuation system for moving the closure panel in a powered assist mode, according to aspects of the disclosure;

FIG. 9 illustrates a powered counterbalance actuator for moving the lift gate of FIG. 2 according to aspects of the disclosure;

FIG. 10 is a block diagram of a controller circuit for an electronic motor assembly, according to aspects of the disclosure;

FIG. 11 is a block diagram of a control system for a closure panel actuator, in accordance with aspects of the disclosure;

FIG. 12 is a block diagram of the control system of FIG. 11, further illustrating sensing systems, in accordance with aspects of the disclosure;

FIG. 13 is a schematic diagram of the control system of FIG. 11, in accordance with additional aspects of the disclosure;

FIG. 14A is graph illustrating a force output of a biasing member acting on a lift gate as a function of lift gate angle/position, in accordance with aspects of the disclosure;

FIG. 14B is graph illustrating a target force output of a counterbalance spring module as a function of the force output of a biasing member of FIG. 14A, in accordance with aspects of the disclosure;

FIG. 15 is flow chart illustrating an configuration of the counterbalance spring module, in accordance with aspects of the disclosure;

FIG. 16 shows a possible distributed configuration of the components of the control system of FIG. 11, and more particularly illustrating a haptic control algorithm remote from the actuator assembly, in accordance with aspects of the disclosure;

FIG. 17 shows yet another possible distributed configurations of the components of the control system of FIG. 11, and more particularly illustrating a haptic control algorithm of a main vehicle controller, in accordance with aspects of the disclosure; and

FIG. 18 is an example method of operation of the actuation system for providing a hold open function for a lift gate, in accordance with aspects of the disclosure.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

In the following description, details are set forth to provide an understanding of the disclosure. In some instances, certain software, circuits, structures, techniques and methods have not been described or shown in detail in order not to obscure the disclosure. The term “control unit” is used herein to refer to any machine for processing data, including the data processing systems, computer systems, modules, electronic control units (“ECUs”), controllers, microprocessors or the like for providing control of the systems described herein, which may include hardware components and/or software components for performing the processing to provide the control of the systems described herein. A computing device is another term used herein to refer to any machine for processing data including microprocessors or the like for providing control of the systems described herein. The present disclosure may be implemented in any computer programming language (e.g., control logic) provided that the operating system of the control unit provides the facilities that may support the requirements of the present disclosure. Any limitations presented would be a result of a particular type of operating system or computer programming language and would not be a limitation of the present disclosure. The present disclosure may also be implemented in hardware or in a combination of hardware and software.

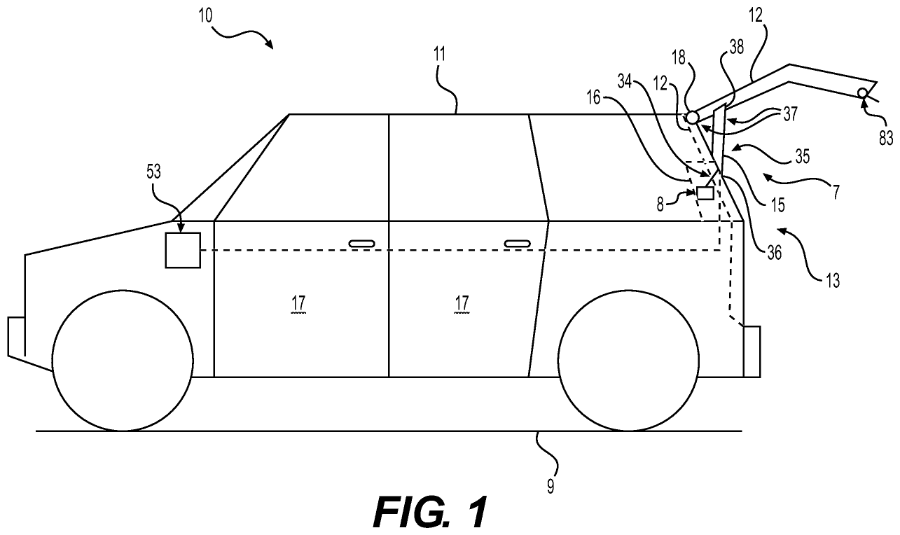

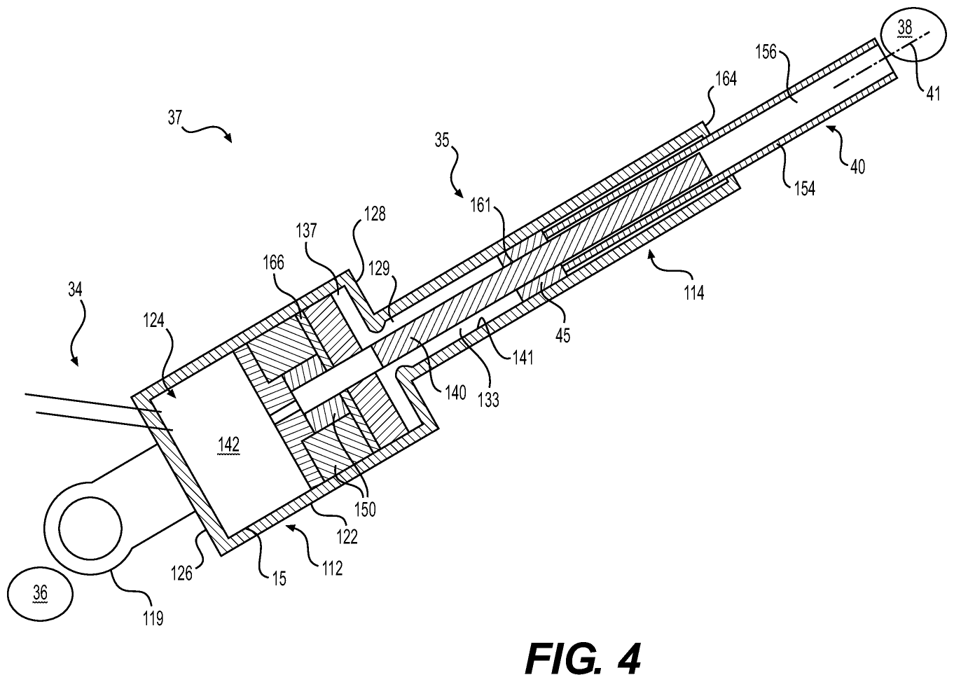

Referring to FIGS. 1 and 4, an electronic motor assembly 15 is integrated within a housing 35 of an electromechanical biasing member 37 such as a spring loaded strut, for example provided as a component of a closure panel assembly 7, as further described below. The housing 35 also contains an extension member 40 used to extend from, or retract within, the housing 35 to effect the resulting location of the closure panel (e.g., lift gate 12) with respect to a vehicle body 11 of the vehicle 10. For example, an extended extension member 40 results in positioning the closure panel or lift gate 12 in an open state, while a retracted extension member 40 results in positioning the closure panel 12 in a closed state with respect to opening 13. It is recognized that the electromechanical biasing member 37, incorporating the electronic motor assembly 15, can be implemented as a strut (see FIG. 4 as an example type of struts). The strut can be of a biasing type (e.g., spring and/or gas charge supplying the bias). As such, via the incorporation of the electronic motor assembly 15, the strut is an electromechanical system, driven by the electronic motor assembly 15 with optionally spring and/or gas charge supplying the bias.

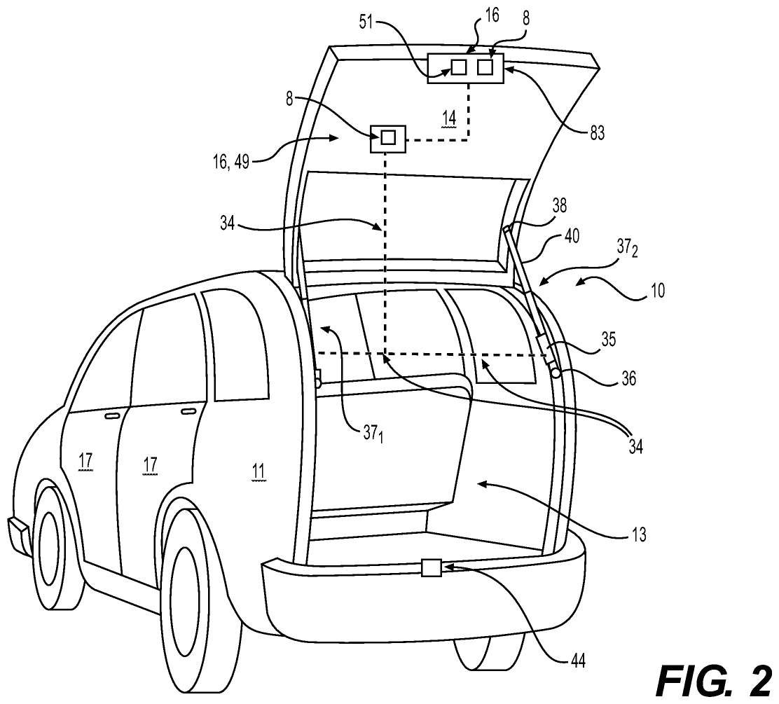

Referring to FIGS. 1 and 2, shown is the vehicle 10 with the vehicle body 11 having one or more closure panels 12. One example configuration of the closure panel 12 is a closure panel assembly 7 including electronic motor assembly 15 (e.g., incorporated in a electromechanical biasing member 37 embodied as a strut by example) and one or more vehicle control systems 16, such as a Body Control Module (BCM) 52, closure panel node control module 49, a latch control module, a smart latch 83, or other vehicle control system which are mounted in other locations on the vehicle body 11 (i.e. spaced apart and external/remote from the electronic motor assembly 15) and/or within the closure panel 12, and are coupled to the electronic motor assembly 15 via a communication path illustratively established over electrical connection(s) 34 (e.g., wired and/or wireless communication—see FIGS. 2 and 4). For example, the electrical connection(s) 34 can be used to supply operating power to the electronic motor assembly 15, which may be illustratively provided from a main vehicle power source 53, such as the vehicle main battery, or other power source and/or backup energy source. For example, the electrical connection(s) 34 can be used to facilitate data and/or command signal communication between a signal source 8 (e.g., located remote to the housing 35 such as but not limited to the vehicle control system 16) and the electronic motor assembly 15. For example, the electrical connection(s) 34 can be used to supply both operating power to the electronic motor assembly 15 as well as facilitating data and/or command signal communication between the signal source 8 (located remote to the housing 35) and the electronic motor assembly 15. For example, the electrical connector(s) 34 can be configured to communicate signals associated with Local Interconnect Network protocol signals, power supply signals, and electrical ground signals. It is recognized that a battery or other type of backup power source (not shown) can be housed in the housing 35 in applications where the housing 35 footprint (e.g., dead length) is not a limiting constraint, and thus used to supply power to the electronic motor assembly 15, such that the electrical connection(s) 34 can be used to charge the battery periodically. In one embodiment, the electrical connection(s) 34 can be used to supply both power and data/command signaling. In a further embodiment, the electrical connection(s) 34 can be used to supply power while data/command signaling is provided via wireless communication.

For vehicles 10, the closure panel 12 can be referred to as a partition or door, typically hinged, but sometimes attached by other mechanisms such as tracks, in front of the opening 13 which is used for entering and exiting the vehicle 10 interior by people and/or cargo. It is also recognized that the closure panel 12 can be used as an access panel for vehicle 10 systems such as engine compartments and also for traditional trunk compartments of automotive type vehicles 10. The closure panel 12 can be opened to provide access to the opening 13, or closed to secure or otherwise restrict access to the opening 13. It is also recognized that there can be one or more intermediate hold positions of the closure panel 12 between a fully opened position and fully closed position, which can be facilitated by operation of the electronic motor assembly 15. For example, the electronic motor assembly 15 can assist in movement of the closure panel 12 to/away from one or more intermediate hold position(s), also known as Third Position Hold(s) (TPHs) or Stop-N-Hold(s), once positioned therein. The electronic motor assembly 15 can assist with the opening and closing of the closure panel 12 in a desired manner, such as based upon a desired speed of movement, the desired third position holds, the desired anti-pinch functionality whereby the movement of the closure panel 12 is stopped from closing to avoid objects, obstacles, and limb members (e.g., fingers) from being pinched between the closure panel 12 and the vehicle body 11, and the desired obstacle detection functionality whereby the closure panel 12 is stopped to avoid obstacles and objects from being impacted by the moving closure panel 12.

In terms of vehicles 10, the closure panel 12 can be a lift gate as shown in FIG. 1, or it may be some other kind of closure panel 12, such as an upward-swinging vehicle door (i.e. what is sometimes referred to as a gull-wing door) or a conventional type of door that is hinged at a front-facing or back-facing edge of the door, and so allows the door to laterally swing (or slide) away from (or towards) the opening 13 in the vehicle body 11 of the vehicle 10. Also contemplated are sliding door embodiments of the closure panel 12 and canopy door embodiments of the closure panel 12, such that sliding doors can be a type of door that opens by sliding horizontally or vertically, whereby the door is either mounted on, or suspended from a track that provides for a larger opening 13 for equipment to be loaded and unloaded through the opening 13 without obstructing access. Canopy doors are a type of door that sits on top of the vehicle 10 and lifts up in some way, to provide access for vehicle passengers via the opening 13 (e.g., car canopy, aircraft canopy, etc.). Canopy doors can be connected (e.g., hinged at a defined pivot axis and/or connected for travel along a track) to the vehicle body 11 of the vehicle 10 at the front, side or back of the door, as the application permits.

Referring again to FIG. 1, in the context of a vehicle application of a closure panel 12 by example only, the closure panel 12 is movable between a closed position (shown in dashed outline) and an open position (shown in solid outline). In the embodiment shown, the closure panel 12 pivots between the open position and the closed position about a pivot axis 18, which is preferably configured as horizontal or otherwise parallel to a support surface 9 of the vehicle 10. In other embodiments, the pivot axis 18 can have some other orientation such as vertical or otherwise extending at an angle outwards with respect to the support surface 9 of the vehicle 10. In still other embodiments, the closure panel 12 can move in a manner other than pivoting, for example, the closure panel 12 can translate along a predefined track or can undergo a combination of translation and rotation between the opened and closed positions.

Referring again to FIG. 1, exemplary embodiments of the electronic motor assembly 15 (provided below) for the closure panel assembly 7 can be used as the means of open and close assistance for the closure panels 12 themselves (see FIG. 2), or can be used in combination (e.g., in tandem or otherwise integrated) with one or more other closure panel biasing members 37 (e.g., spring loaded hinges, struts such as gas struts or spring loaded struts, etc.) that provide a primary connection of the closure panel 12 to the vehicle body 11 at a pivot connection 36 (see FIG. 1). In general configuration of the closure panel assembly 7, the electronic motor assembly 15 can be incorporated within a housing 35 (also referred to as lever mechanism or arm or element) used to connect the closure panel 12 as a secondary connection of the closure panel 12 to the vehicle body 11, such that the extension member 40 and the housing 35 (of the closure panel electromechanical biasing member 37) can be pivotally attached to the closure panel 12 at spaced apart pivot connections 36, 38 as shown. In this manner, the end of the housing 35 pivotally connects to the closure panel 12 at pivot connection 38. It is recognized that the housing 35 itself can be configured to contain a non-biasing element (e.g., a solid extension rod 40) or can be configured to contain a biasing element (e.g., a gas or spring assisted extension strut containing biasing element(s)) along with the extension member 40, as desired.

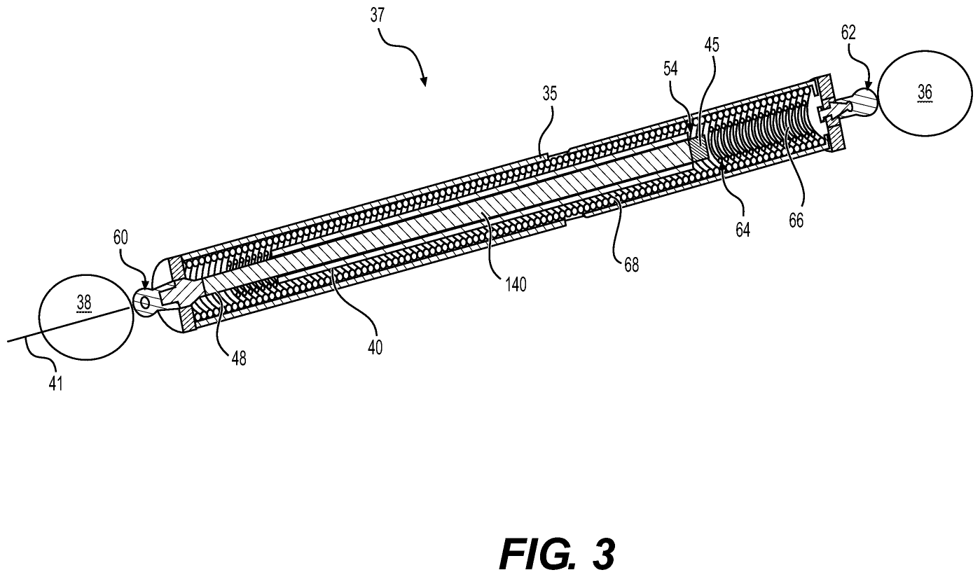

Referring again to FIG. 1, one or more optional closure panel biasing members 37 can be provided which urge the closure panel 12 towards the open position throughout at least some portion of the path between the opened position and the closed position and which assist in holding the closure panel 12 in the opened position. The closure panel biasing members 37 can be, for example, gas extension struts which are pivotally connected at their proximal end to the closure panel 12 and at their distal end to the vehicle body 11. In the embodiment shown in FIG. 2, there are two biasing members 37 (one on the left side (i.e. closure panel biasing member 37₁) of the vehicle 10 and one on the right side (i.e. closure panel biasing member 37₂) of the vehicle 10), such that the closure panel assembly 7 includes the closure panel 12 and a pair of biasing members 37 acting to control the movement of the closure panel 12. It is recognized that one or both of the biasing members 37 can incorporate the electronic motor assembly 15 within the housing 35, i.e. thus configured as the electromechanical biasing member 37. In one example, see FIG. 4, the electronic motor assembly 15 is incorporated within the electromechanical biasing member 37 in order to provide a motorized version, such that the extension member 40 is actively driven by the electronic motor assembly 15 via a lead screw 140, or drive screw 140. The second biasing member 37₂ is positioned at another side of the closure panel 12, as a same or differently configured biasing member 37₁. In the embodiment as a differently configured biasing member 37₂, the housing 35 does not contain (see FIG. 3) any electronic motor assembly 15 and as such this biasing member 37₂ would be passively operated by motion of the closure panel 12. In either configuration, it is recognized that during operation of the biasing member(s) 37, the extension member 40 is either extended from, or retracted into, the housing 35.

The closure panel 12 can be opened by being powered electronically via the electronic motor assembly 15, for example in cooperation with one or more vehicle control systems 16, where powered closure panels 12 can be found on minivans, high-end cars, or sport utility vehicles (SUVs) and the like. Additionally, one characteristic of the closure panel 12 is that due to the weight of materials used in manufacture of the closure panel 12, some form of force assisted open and close mechanism (or mechanisms) are used to facilitate operation of the open and close operation by an operator (e.g., vehicle driver) of the closure panel 12. The force assisted open and close mechanism(s) is/are provided by the electronic motor assembly 15, any biasing member(s) 37 (e.g., spring loaded hinges, spring loaded struts, gas loaded struts, electromechanical struts, etc.) when used as part of the closure panel assembly 7.

It is recognized that the electromechanical biasing member 37 can have a lead screw 140 (e.g., rotary output member—see FIG. 4) operated actively (i.e. driven) by a motor 142 (e.g., an electrical, brushed or brushless, motor, such as a direct current (DC) electric motor) or operated passively such that the lead screw 140 is free to rotate about its longitudinal axis but is not actively driven by a motor 142 (e.g., in the event of electrical system failure of the vehicle 10) of the electronic motor assembly 15. It is recognized that the electronic motor assembly 15 is configured as an internal component of the electromechanical biasing member 37 (e.g., incorporated as a component positioned wholly within the housing 35), as further provided below. The springs 66, 68 may provide a counterbalance force to the weight of the closure panel 12 to assist with the movement of the closure panel 12.

Referring to FIG. 3, shown is a biasing member 37 (non-motorized) referred to as a biasing strut with the housing 35 (e.g., a body) having a first end 60 for connecting to the closure panel 12 (or a vehicle body/frame 11) and a second end 62 for connecting to the vehicle body/frame 11 (or the closure panel 12), depending upon the configuration orientation of the biasing member 37 when installed in the closure panel assembly 7 (see FIG. 1). In this configuration, the biasing member 37, by example only, has the extension member 40 (e.g., a stator member, such as a linear drive nut 45, slideably engageable with the rotary output member such as via a mated threads) positioned in an interior 64 of the housing 35. A distal end 54 of the extension member 40 is coupled to the second end 62 (for example via an optional element 66—spring) of the biasing member 37 (e.g., strut) and the proximal end 48 of the extension member 40 is coupled to the first end 60. The extension member 40 is coupled to the lead screw 140 via the travel member 45 (for example as an integral part of or separate to the extension member 40), such that rotation of the lead screw 140 causes travel of the travel member 45 along the lead screw 140, to result in extension or retraction of the extension member 40 with respect to the housing 35. As discussed in relation to FIG. 4, the travel member 45 and the lead screw 140 are coupled to one another via mated threads. As shown, the electromechanical biasing member 37 can be a strut having a resilient element of the power spring 68 for providing the counterbalance torque (T) during operation of the closure panel 12 in moving between the opened and closed positions (see FIG. 1).

Referring again to FIG. 3, the travel member 45 is positioned at one end of the extension member 40. The extension member 40 is coupled (in this example case via a mounted kicker spring 66) to the closure panel 12 (see FIG. 1) or the vehicle body 11 at the distal end 54. Complimentary, the extension member 40 is coupled to the vehicle body 11 or the closure panel 12 at the proximal end 48. As such, as the extension member 40 is displaced along the longitudinal axis 41, the attached travel member 45 is displaced along the lead screw 140. As such, as the closure panel 12 is moved between the opened and closed positions (see FIG. 1), the position of the travel member 45 along the lead screw 140 varies, thereby providing for reciprocation of the travel member 45 along the longitudinal axis 41 of the lead screw 140.

Referring now to FIG. 4, an embodiment of the electromechanical biasing member 37 containing the electronic motor assembly 15 for the vehicle 10 is shown. The electromechanical biasing member 37 includes the housing 35 having a lower housing 112 for containing the electronic motor assembly 15 and an upper housing 114 for containing the extension member 40 (e.g., extension shaft/rod). It is recognized that preferably the lower housing 112 and upper housing 114 are of similar lateral (e.g., diameter) dimension provided along its longitudinal length, however the housings 112,114 are shown in FIG. 4 with differing dimensions for exemplary purposes. A second pivot mount (not shown) is attached to the distal end of extension member 40, relative to upper housing 114, and can be pivotally mounted to the lift gate 14 of the vehicle 10. As described below, the electronic motor assembly 15 is contained wholly within the confines of the housing 35 of the electromechanical biasing member 37, and is thus supplied with power/data/command signals via the electrical connections 34 configured to penetrate the housing 35 through a sealed housing end wall or other port. In particular, both electronic control circuitry (e.g., actuator controller 50 including a processor or other computing unit 110) for the motor 142, and the motor 142 itself, are mounted within the interior of the housing 35 without increasing the dimensions of the housing 35.

The interior of the lower housing 112 is now described in greater detail, by example. Lower housing 112 provides a (e.g., cylindrical or tubular) sidewall 122 defining a chamber 124, or cavity. Pivot mount 121 is attached to an end wall 126 of lower housing 112 proximal to the vehicle body 11. Upper housing 114 provides a (e.g., cylindrical or tubular) sidewall 141 defining a chamber 133 that is open at both ends. A distal end wall 128 of lower housing 112 includes an aperture 129 so that chamber 124 and chamber 133 communicate with each other. Upper housing 114 can have a smaller diameter than lower housing 112. However, it is contemplated that lower housing 112 and upper housing 114 can also be formed as a single cylinder or frusto-cone. Other form factors for lower housing 112 and upper housing 114 will occur to those of skill in the art. Upper housing 114 can be integrally formed with lower housing 112, or it can be secured to lower housing 112 through conventional means (threaded couplings, weld joints, etc). An electronic motor assembly 15 is seated in chamber 124 and is an integral component of the electromechanical strut 37 (e.g., situated internally in the housings 112, 114 as shown rather than situated external to the housings 112,114 as contemplated by existing state of the art designs). For example, the housing 35 can comprise one or more sections (e.g., lower housing 112, upper housing 114) having a cross sectional shape of circular, of rectilinear (e.g., square), etc.

The electronic motor assembly 15 can include a motor 142 (e.g., a brushless electric motor, or a brushed electric motor), a clutch and planetary gearbox 150, and a lead screw 140 (or referred to as a drive screw 140 or rotary output member powered by rotary motion of the motor 142) which can be used to transport or otherwise guide a travel member 45 (connected to the extension member 40) along the longitudinal axis 41 of the electromechanical biasing member 37. Motor 142 is mounted within chamber 124 adjacent to end wall 126. Motor 142 can be a direct current bi-directional motor. Electrical power and/or direction control for motor 142 can be provided via the electrical connections (e.g., cables or wires) 110 that connect into the electromechanical biasing member 37 through apertures or ports into the interior of the housing 35 (e.g., in end wall 126), and are otherwise connected to operator handles, a vehicle latch, such as latch 83, buttons, an actuator and/or other vehicle control systems 16 (e.g., a potential source of the power and/or data/command signal(s)), as desired. It is recognized that the electrical connection(s) 34 can be an example of an electrical connector that penetrates the housing 35 to provide electrical communication with a computing device, such as actuator controller 50 from and/or to the source 8 (e.g., vehicle control system 16, handle, latch, button, etc.) positioned external and remote to the housing 35.

The clutch and planetary gearbox 150 are connected to an output shaft on motor 142. The clutch and planetary gearbox 150 can provide a selective engagement between the output shaft of motor 142 and the clutch and planetary gearbox 150. The clutch and planetary gearbox 150 can be an electromechanical tooth clutch that engages planetary gearbox when motor 142 is activated, for example. When the clutch and planetary gearbox 150 are engaged, torque is transferred from motor 142 through to the planetary gearbox 150. When clutch is disengaged, torque is not transferred between motor 142 and planetary gearbox so that occurrence of back drive of the motor 142 can be limited if the closure panel 12 is closed manually. For example, the planetary gearbox 150 can be a two-stage planetary gear that provides torque multiplication for lead screw 140. Lead screw 140 extends into upper housing 114. As such it is recognized that in the case where the electronic motor assembly 15 is present, the lead screw 140 can be driven, i.e. actively rotated by the rotary motion of the electronic motor assembly 15 coupled to the lead screw 140 via the travel member 45. For example, the travel member 45 contains an internally facing series of threads in bore 161 that are mated to an externally facing series of threads on the extension member 40, as desired. Alternatively, in the case where the electronic motor assembly 15 is not present/engaged, the lead screw 140 can rotate about the longitudinal axis 41 under the influence of friction present between the travel member 45 and the lead screw 140 in the bore 161, i.e. passively rotated by the linear motion of the travel member 45 as it rotates about the lead screw 140.

Extension member 40 resides within a (e.g., cylindrical or tubular) sidewall 154 of the housing 35 defining a chamber 156 and can be concentrically mounted between upper housing 114 and lead screw 140. As described earlier, pivot mount 38 is attached to the distal end of extension member 40. The proximal end of extension member 40 can be open. A nut 45 (also referred to as the travel member 45) is mounted around the proximal end of extension member 40 relative to lower housing 112 and is coupled with lead screw 140 in order to convert the rotational movement of lead screw 140 into the linear motion of the extension member 40 along the longitudinal axis 41 of lead screw 140. The nut 45 can include splines that extend into opposing coaxial slots provided on the inside of upper housing 114 to inhibit nut 45 from rotating as the nut 45 travels along the longitudinal axis 41. Alternatively, the nut 45 may be configured without the splines and thus be free to rotate as the nut 45 travels along the longitudinal axis 41, without departing from the scope of the description. An integrally-formed outer lip 164 in upper housing 114 can provide an environmental seal between the chamber 133 and the outside.

A spring housing 137 can be provided in lower housing 112 and defined by a sidewall 122, end wall 128, and a flange 166. Within spring housing 137, a power spring (not shown in FIG. 4) similar to the power spring 68 as seen in FIG. 3 can be optionally coiled around lead screw 140, providing a mechanical counterbalance to the weight of the lift gate 14. Preferably formed from a strip of steel, power spring 68 assists in raising the lift gate 14 both in its powered and unpowered modes of the electromechanical strut 37 and alleviates the loading on the motor 142 due to the weight of the closure panel 12. One end of power spring 68 is positioned or otherwise attached to the travel member 45 and the other is secured to a portion of the sidewall 122. When extension member 40 is in its retracted position, power spring 68 is tightly coiled around lead screw 140 and therefore applies bias against the travel member 45. As lead screw 140 rotates to extend extension member 40, in concert with travel of the travel member 45 along the upper housing 114, power spring 68 uncoils, releasing its stored energy and transmitting an axial force through extension member 40 to help raise the lift gate 14. When power screw 140 rotates to retract extension member 40, in concert with travel of the travel member 45 along the upper housing 114, the power spring 68 recharges by recoiling around lead screw 140. It is recognized that other forms of counterbalance assist configurations may be provided for assisting with the movement of the closure panel 12 by the electronic motor assembly 15 (e.g. alleviating the strain and loading due to the weight of the closure panel 12 placed upon the motor 142).

As such, in view of the above, the integrated electronic motor assembly 15 can be incorporated into a number of different electromechanical biasing member 37 form factors. One example is the strut with lead screw 140 such that the travel member 45 only travels linearly along the longitudinal axis 41. Another example is the strut with lead screw 140 such that the travel member 45 travels both linearly along the longitudinal axis 41 and rotationally about the longitudinal axis 41 (i.e. helical relative motion).

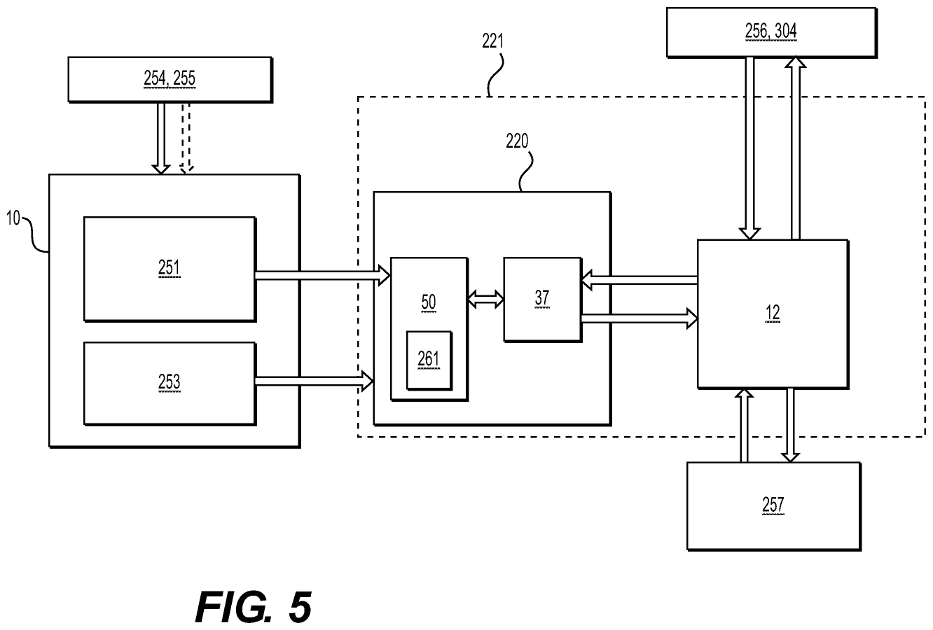

FIG. 5 illustrates a block diagram of a power closure panel actuation system 220 of a power closure panel system 221 for moving the closure panel (e.g., lift gate 12) of the vehicle 10 between open and closed positions relative to the vehicle body 11. The power closure panel actuation or actuator system 220 includes at least one electromechanical biasing member 37 (i.e., actuator assembly) that is coupled to the closure panel (e.g., lift gate 12) and the vehicle body 11. As discussed above, the electromechanical biasing member 37 is configured to move the closure panel 12 relative to the vehicle body 11. The power closure panel actuation system 220 also includes the actuator controller 50 that is coupled to the actuator assembly or electromechanical biasing member 37 and in communication with other vehicle systems (e.g., the closure panel node control module 49 or body control module (BCM) 52) and also receives vehicle power from the vehicle 10 (e.g., from the vehicle battery 53).

The actuator controller 50 is operable in at least one of an automatic mode (in response to an automatic mode initiation input 254) and a powered assist mode (in response to a motion input 256). In the automatic mode, the actuator controller 50 commands movement of the closure panel through a predetermined motion profile (e.g., to open the closure panel). The powered assist mode is different than the automatic mode in that the motion input 256 from the user 275 may be continuous to move the closure panel, as opposed to a singular input by the user 275 in automatic mode. Actuator controller 50 may therefore be configured as a servo controller which may for example receive electrical signals indicative of the position of the closure panel from the closure panel actuation system 220, such as a high position count sensor as will be described in more details herein below as an illustrative example, and in response send electrical signals to the electromechanical biasing member 37 based on the received high position count signals to move the closure panel or member 12. No separate button or switch activations by user 275 are needed to move the closure panel 12, the user 275 only requires to directly move the closure panel 12. Commands 251 from the vehicle systems may, for example, include instructions the actuator controller 50 to open the closure panel, close the closure panel, or stop motion of the closure panel. Such control inputs, such as inputs 254, 256 may also include other types of inputs 255, such as an input from a body control module, which may receive a wireless command to control the closure panel opening based on a signal such as a wireless signal received from the key fob 260, or other wireless device such as a cellular smart phone, or from a sensor assembly provided on the vehicle, such as a radar or optical sensor assembly detecting an approach of a user 275, such as a gesture or gait e.g., walk of the user 275 upon approach of the user 275 to the vehicle. Also shown are other components that may have an impact on the operation of the power closure panel actuation system 220, such as closure panel seals 257 of the closure panel 12, for example. In addition, environmental conditions 259 (rain, cold, heat, etc.) may be monitored by the vehicle 10 (e.g., by the body control module 52) and/or the actuator controller 50. The actuator controller 50 also includes an artificial intelligence learning algorithm 261 (e.g., series of nodes forming a neural network model), discussed in more detail below.

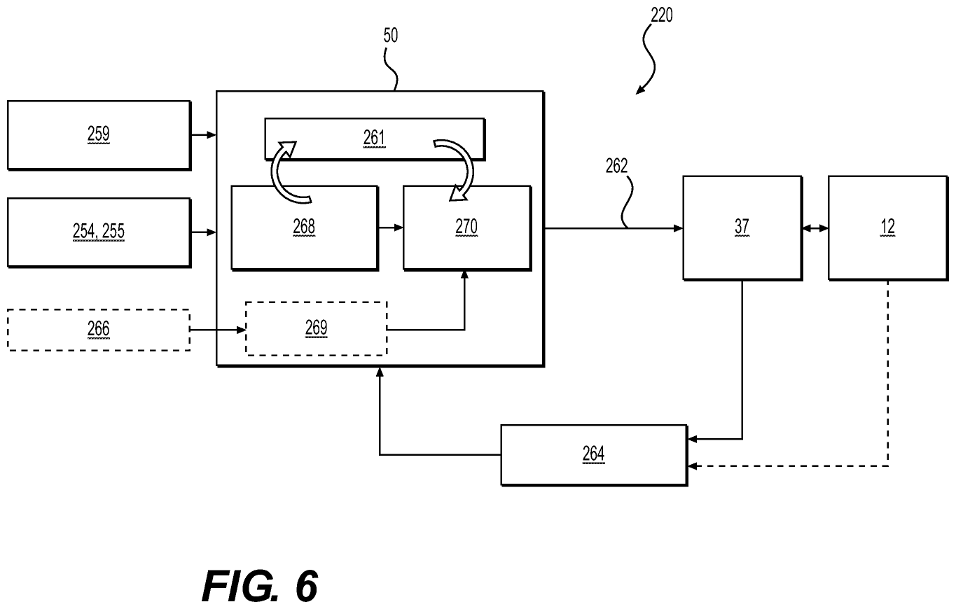

Referring now to FIG. 6, the actuator controller 50 is configured to receive the automatic mode initiation input 254 and enter the automatic mode to output a motion command 262 in response to receiving the automatic mode initiation input 254 or input motion command 262. The automatic mode initiation input 254 can be a manual input on the closure panel itself or an indirect input to the vehicle (e.g., closure panel switch 258 on the closure panel, switch on a key fob 260, etc.). So, the automatic mode initiation input 254 may, for example, be a result of the user 275 or operator operating a switch (e.g., the closure panel switch 258), making a gesture near the vehicle 10, or possessing a key fob 260 near the vehicle 10, for example. It should also be appreciated that other automatic mode initiation inputs 254 are contemplated, such as, but not limited to a proximity of the user 275 detected by a proximity sensor.

In addition, the power closure panel actuation system 20 includes at least one closure panel feedback sensor 264 for determining at least one of a position and a speed and an attitude of the closure panel. Thus, the at least one closure panel feedback sensor 264 detects signals from either the electromechanical biasing member 37 by counting revolutions of the electric motor 15, 142, absolute position of an extensible member (not shown), or from the closure panel 12 (e.g., an absolute position sensor on a door check as an example) can provide position information to the actuator controller 50. Feedback sensor 264 in communication with actuator controller 50 is illustrative of part of a feedback system or motion sensing system for detecting motion of the closure panel directly or indirectly, such as by detecting changes in speed and position of the closure panel 12, or components coupled thereto. For example, the motion sensing system may be hardware based (e.g. a hall sensor unit an related circuitry) for detecting movement of a target on the closure panel (e.g. on the hinge) or electromechanical biasing member 37 (e.g. on a motor shaft) as examples, and/or may also be software based (e.g. using code and logic for executing a ripple counting algorithm) executed by the actuator controller 50 for example. Other types of position, speed, and/or orientation detectors such as accelerometers and induction based sensors may be employed without limitation.

The power closure panel actuation system 220 additionally includes at least one non-contact obstacle detection sensor 266 which may form part of a non-contact obstacle detection system coupled, such as electrically coupled, to the actuator controller 50. The actuator controller 50 is configured to determine whether an obstacle is detected using the at least one non-contact obstacle detection sensor 266 (e.g., using a non-contact obstacle detection algorithm 269) and may, for example, cease movement of the closure panel in response to determining that the obstacle is detected. The non-contact obstacle detection system may also be configured to calculate distance from the closure panel to the object or obstacle, or to the user 275 as the object or obstacle, to the lift gate 12. For example non-contact obstacle detection system may be configured to perform time of flight calculations to determine distance using a radar based sensor 266 or to characterize the object as the user 275 or human as compared to an non-human object for example based on determining the reflectivity of the object using a radar based sensor 266 and system. The non-contact obstacle detection system may also be configured determine when an obstacle is detected, for example by detecting reflected waves of the object or obstacle or user of radar transmitted from the obstacle sensor 266. The non-contact obstacle detection system may also be configured determine when an obstacle is not detected, for example by not detecting reflected waves of the object or obstacle or user of radar transmitted from the obstacle sensor 266. The operation and example of the at least one non-contact obstacle detection sensor 266 and system are discussed in U.S. Patent Application No. 2018/0238099, incorporated herein by reference.

In the automatic mode, the actuator controller 50 can include one or more closure panel motion profiles 268 that are utilized by the actuator controller 50 when generating the motion command 262 (e.g., using a motion command generator 270 of the actuator controller 50) in view of the obstacle detection by the at least one non-contact obstacle detection sensor 266. So, in the automatic mode, the motion command 62 has a specified motion profile 268 (e.g., acceleration curve, velocity curve, deceleration curve, and finally stops at an open position) and is continually optimized per user feedback (e.g., automatic mode initiation input 254).

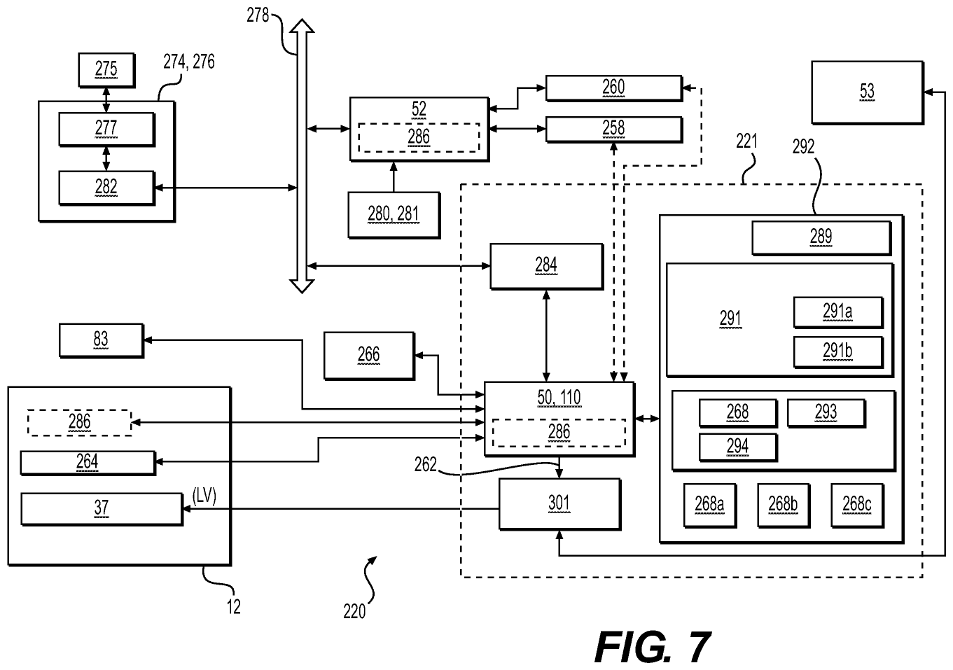

In FIG. 7, the power closure panel actuation system 220 is shown as part of a vehicle system architecture 272 corresponding to operation in the automatic mode. The power closure panel actuation system 220 includes a user interface 274, 276 that is configured to detect a user interface input from a user 275 via an interface 277 (e.g., touchscreen) to modify at least one stored motion control parameter associated with the movement of the closure panel. Thus, the actuator controller 50 of the power closure panel actuation system 220 or user modifiable system is configured to present the at least one stored motion control parameter on the user interface 274, 276.

The body control module 52 is in communication with the actuator controller 50 via a vehicle bus 278 (e.g., a Local Interconnect Network or LIN bus). The body control module 52 can also be in communication with the key fob 260 (e.g., wirelessly) and a closure panel switch 258 configured to output a closure panel trigger signal through the body control module 52. Alternatively, the closure panel switch 258 could be connected directly to the actuator controller 50 or otherwise communicated to the actuator controller 50. The body control module 52 may also be in communication with an environmental sensor (e.g., temperature sensor 280). The actuator controller 50 is also configured to modify the at least one stored motion control parameter in response to detecting the user interface input. A screen communications interface control unit 282 associated with the user interface 274, 276 can, for example, communicate with a closure communications interface control unit 284 associated with the actuator controller 50 via the vehicle bus 278. In other words, the closure communication interface control unit 284 is coupled to the vehicle bus 278 and to the actuator controller 50 to facilitate communication between the actuator controller 50 and the vehicle bus 278. Thus, the user interface input can be communicated from the user interface 274, 276 to the actuator controller 50.

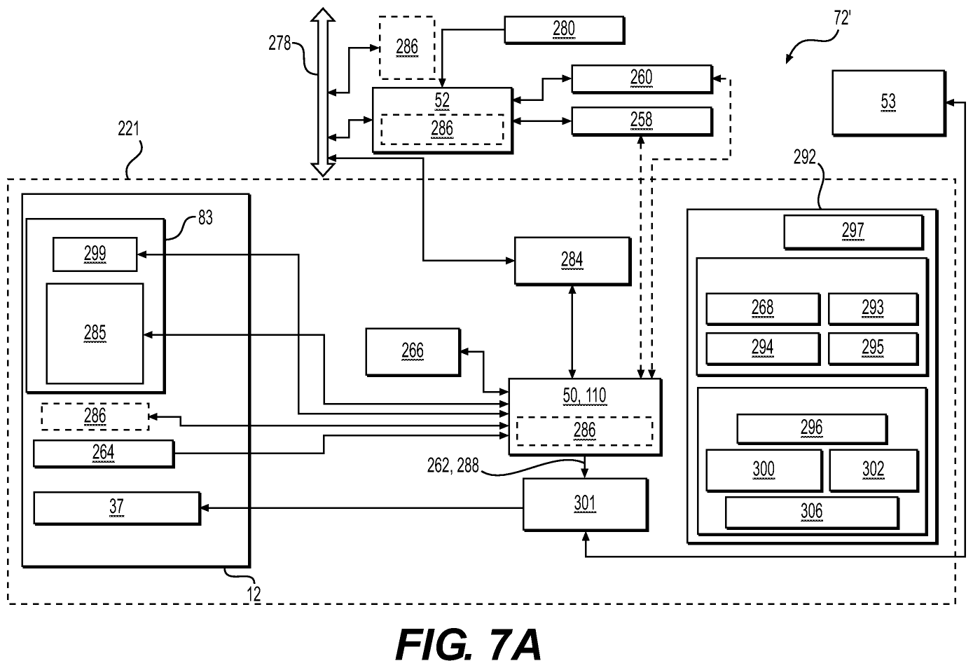

A vehicle inclination sensor 286 (such as an accelerometer) is also coupled to the actuator controller 50 for detecting an inclination of the vehicle 10. The vehicle inclination sensor 286 outputs an inclination signal corresponding to the inclination of the vehicle 10 and the actuator controller 50 is further configured to receive the inclination signal and adjust the one of a force command 288 (FIG. 8) and the motion command 262 accordingly. While the vehicle inclination sensor 286 may be separate from the actuator controller 50, it should be understood that the vehicle inclination sensor 286 may also be integrated in the actuator controller 50 or in another control module, such as, but not limited to the body control module 52.

The actuator controller 50 is further configured to perform at least one of an initial boundary condition check prior to the generation of the command signal (e.g., the force command 288 or the motion command 262) and an in-process boundary check during the generation of the command signal. Such boundary checks prevent movement of the closure panel and operation of the electromechanical biasing member 37 outside a plurality of predetermined operating limits or boundary conditions 291 and will be discussed in more detail below.

The actuator controller 50 can also be coupled to a vehicle latch 83. In addition, the actuator controller 50 is coupled to a memory device 292 having at least one memory location for storing at least one stored motion control parameter associated with controlling the movement of the closure panel (e.g., lift gate 12). The memory device 292 can also store one or more closure panel motion profiles 268 (e.g., movement profile A 268a, movement profile B 268b, movement profile C 268c) and boundary conditions 291 (e.g., the plurality of predetermined operating limits such as minimum limits 291a, and maximum limits 291b). The memory device 292 also stores original equipment manufacturer (OEM) modifiable closure panel motion parameters 289 (e.g., closure panel check profiles and pop-out profiles).

The actuator controller 50 is configured to generate the motion command 262 using the at least one stored motion control parameter to control an actuator output force acting on the closure panel to move the closure panel. A pulse width modulation unit 301 is coupled to the actuator controller 50 and is configured to receive a pulse width control signal and output an actuator command signal corresponding to the pulse width control signal.

Similar to FIG. 7, FIG. 7A shows the power closure panel actuation system 220 as part of another vehicle system architecture 272′ operable in the automatic mode and the powered assist mode. The body control module 52 may also be in communication with at least one environmental sensor 280, 281 for sensing at least one environmental condition 259. Specifically, the at least one environmental sensor 280, 281 can be at least one of a temperature sensor 280 or a rain sensor 281. While the temperature sensor 280 and rain sensor 281 may be connected to the body control module 52, they may alternatively be integrated in the body control module 52 and/or integrated in another unit such as, but not limited to the actuator controller 50. In addition, other environmental sensors 280, 281 are contemplated.

The controller is also coupled with the latch 83 that includes a cinch motor 299 (for cinching the closure panel 12 into the closed position). The latch 83 also includes a plurality of primary and secondary ratchet position sensors or switches 285 that provide feedback to the actuator controller 50 regarding whether the latch 283 is in a latch primary position or a latch secondary position, for example.

Again, the vehicle inclination sensor 286 (such as an accelerometer or inclinometer) is also coupled to the actuator controller 50 for detecting the inclination of the vehicle 10. The vehicle inclination sensor 286 outputs an inclination signal corresponding to the inclination of the vehicle 10 and the actuator controller 50 is further configured to receive the inclination signal and adjust the one of the force command 288 (FIG. 8) and the motion command 262 accordingly. Accordingly may be for example adjusting the motion command 262 such that lift gate 12 moves at the same speed and motion profile as compared to the lift gate 12 being moved by a motion command as if on a level terrain. As a result, the electromechanical biasing member 37 may move the lift gate 12 such that the motion profile (e.g. speed versus closure panel position) when on an incline is the same as or is tracking to the motion profile as if the vehicle was not on an incline. In other words the user 275 detects no visual difference in the closure panel motion appearance of speed versus position as when the vehicle 10 is on an incline or not. Or for example accordingly may be adjusting the force command 288 such that lift gate 12 is moved applying the similar resistance force detected by the user 275 as compared to the lift gate being moved by a force command as if on level terrain. As a result, the electromechanical biasing member 37 may move the lift gate 12 such that the force required to move the lift gate 12 by the user 275 when on an incline is the same as the force required by the user 275 to move the lift gate 12 as if the vehicle 10 was not on an incline. In other words, the user experiences the same reactionary resistive force of the lift gate 12 acting against the input force of the user 275 when the vehicle 10 is on an incline or not.

The pulse width modulation unit 301 is also coupled to the actuator controller 50 and is configured to receive a pulse width control signal and output an actuator command signal corresponding to the pulse width control signal. The actuator controller 50 includes the processor or other computing unit 110 in communication with the memory device 292. So, the actuator controller 50 is coupled to the memory device 292 for storing a plurality of automatic closure panel motion parameters 268, 293, 294, 295 for the automatic mode and a plurality of powered closure panel motion parameters 296, 300, 302, 306 for the powered assist mode and used by the actuator controller 50 for controlling the movement of the closure panel or panel (e.g., lift gate 12). Specifically, the plurality of automatic closure panel motion parameters 268, 293, 294, 295 includes at least one of closure panel motion profiles 268 (e.g., plurality of closure panel velocity and acceleration profiles), a plurality of closure panel stop positions 293, a closure panel check sensitivity 294, and a plurality of closure panel check profiles 295. The plurality of powered closure panel motion parameters 296, 300, 302, 306 includes at least one of a plurality of fixed closure panel model parameters 296 and a force command generator algorithm 300 and a closure panel model 302 and a plurality of closure panel component profiles 306. In addition, the memory device 292 stores a date and mileage and cycle count 297. The memory device 292 may also store boundary conditions (e.g., plurality of predetermined operating limits) used for a boundary check to prevent movement of the closure panel and operation of the electromechanical biasing member 37 outside a plurality of predetermined operating limits or boundary conditions.

Consequently, the actuator controller 50 is configured to receive one of the motion input 256 associated with the powered assist mode and the automatic mode initiation input 254 associated with the automatic mode. The actuator controller 50 is then configured to send the electromechanical biasing member 37 one of a motion command 262 based on the plurality of automatic closure panel motion parameters 268, 293, 294, 295 in the automatic mode and the force command 288 based on the plurality of powered closure panel motion parameters 296, 300, 302, 306 in the powered assist mode to vary the actuator output force acting on the closure panel 12 to move the closure panel 12. The actuator controller 50 additionally monitors and analyzes historical operation of the power closure panel actuation system 220 using the artificial intelligence learning algorithm 261 and adjusts the plurality of automatic closure panel motion parameters 268, 293, 294, 295 and the plurality of powered closure panel motion parameters 296, 300, 302, 306 accordingly.

As discussed above, the power closure panel actuation system 20 can include the environmental sensor 280, 281 in communication with the actuator controller 50 and configured to sense at least one environmental condition of the vehicle 10. Thus, the historical operation monitored and analyzed by the actuator controller 50 using the artificial intelligence learning algorithm 261 can include the at least one environmental condition of the vehicle 10. So, the controller is further configured to adjust the plurality of automatic closure panel motion parameters 268, 293, 294, 295 and the plurality of powered closure panel motion parameters 296, 300, 302, 306 based on the at least one environmental condition of the vehicle 10.

As best shown in FIG. 8, the actuator controller 50 is also configured to receive the motion input 256 and enter the powered assist mode to output the force command 288 (e.g., using a force command generator 298 of the actuator controller 50 as a function of a force command algorithm 300, closure panel model 302, boundary conditions 291, a plurality of closure panel component profiles 306 as discussed in more detail below) as modified by the artificial intelligence learning algorithm 261. The actuator controller 50 is also configured to generate the force command 288 to control an actuator output force acting on the closure panel 12 to move the closure panel 12. So, the actuator controller 50 varies an actuator output force acting on the closure panel to move the closure panel in response to receiving the motion input 256. In the powered assist mode, the force command 288 has a specified force profile (e.g., that may be altered to change the user experience with the closure panel, such as by making it lighter or heavier, or based on changes in the environmental condition and modified by the artificial intelligence learning algorithm 261, such as by increasing or decreasing the force assist provided to the user 275). The force command 288 is continually optimized per current user feedback, for example. A user movement sensor 304 is coupled to the actuator controller 50 and is configured to sense the motion input 256 from the user 275 on the closure panel to move the closure panel. Closure panel motion feedback 305 is also provided from the closure panel (e.g., lift gate 12) back to the user 275. Again, the power closure panel actuation system 220 further includes at least one closure panel feedback sensor 264 for determining at least one of a position and speed of the closure panel. The at least one closure panel feedback sensor 264 detects the position and/or speed of the closure panel, as described above for the automatic mode, and can provide corresponding position/motion information or signals to the actuator controller 50 concerning how the user 275 is interacting with the closure panel. For example, the at least one closure panel feedback sensor 264 determine how fast the user 275 is moving the closure panel (e.g., lift gate 12). The attitude or inclination sensor 286 may also determine the angle or inclination of the closure panel and the power closure panel actuation system 20 may compensate for such an angle to assist the user 275 and negate any effects on the closure panel motion that the change in angle causes (e.g., for example changes regarding how gravity may influence the closure panel differently based on the angle of the closure panel relative to a ground plane).

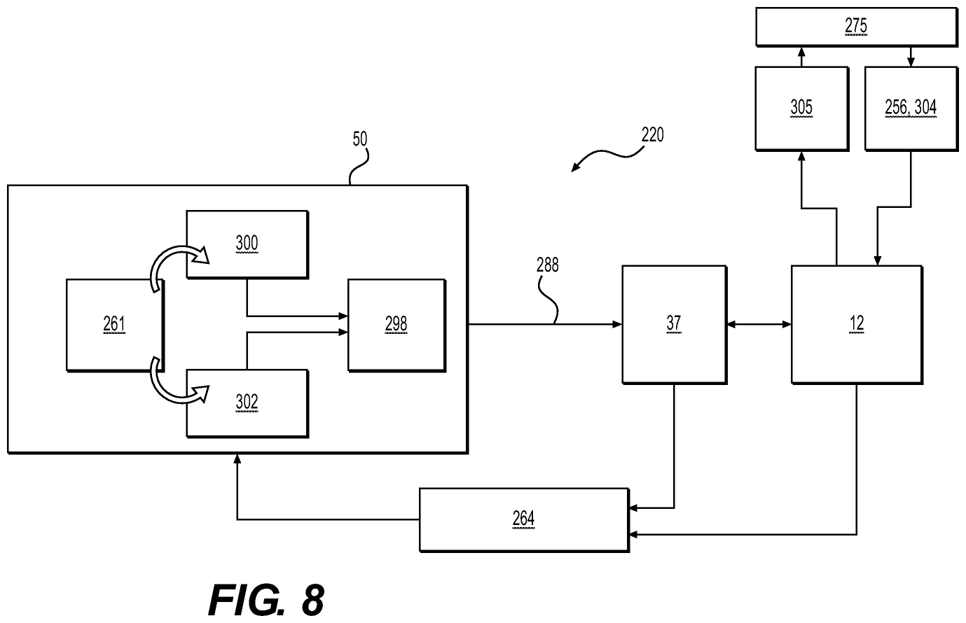

FIG. 9 shows another example electromechanical biasing member 37 constructed according to aspects of the disclosure. As shown, the electromechanical biasing member 37 includes a lower housing 412 having a cylindrical sidewall 422 defining a chamber 424, and an upper housing 414 having cylindrical a sidewall 432 defining a chamber 434. It is appreciated that lower 412 and upper 414 housings may be formed as a single housing. The electromechanical biasing member 37 also includes an extensible shaft 416 movable between a retracted position, corresponding to a closed position of lift gate 12 and an extended position, shown in FIG. 9, corresponding to an open position of lift gate 12.

Motor-gearbox assembly 436 is seated within chamber 424. Motor-gearbox assembly 436 includes electric motor unit 442 with a motor shaft 443 and a geared reduction gearset unit 446 connected thereto for driving power screw 440. Geared reduction unit 446 is a planetary gearset having planet gears 452 that transfer power from a ring gear 450 to a central output gear 451 for rotatably driving power screw 440 via a coupling unit 453. In the current embodiment, planetary gearset 446 provides a 20:1 gear ratio reduction. In this arrangement, coupling unit 453 may act as an integrated flex coupling and slip clutch device.

Extensible shaft 416 extends between opposing first 470 and second 472 ends. First end 470 of extensible shaft 416 is open and second end 472 of extensible shaft 416 is closed off by an end wall 476. Second end 472 of extensible shaft 416 is connected to pivot mount 420.

Extensible shaft 416 includes an outer cylindrical wall 478 and an inner cylindrical wall 480 spaced apart inwardly from outer cylindrical wall 478. One end of inner cylindrical wall 480 is connected to end wall 476. Outer cylindrical wall 478 and inner cylindrical wall 480 define a toroidal chamber 482 therebetween. One end of toroidal chamber 482 is closed off by end wall 476 and an opposing end of toroidal chamber 482 defines an opening 484. Inner cylindrical wall 480 further defines a cylindrical chamber 486 inward of toroidal chamber 482. Cylindrical chamber 486 is separated from toroidal chamber 482 by inner cylindrical wall 480.

Drive nut 458 is rigidly mounted in cylindrical chamber 486 of extensible shaft 416. Drive nut 458 is threadedly coupled with power screw 440 in order to convert the rotational movement of power screw 440 into linear motion of extensible shaft 416 along a longitudinal axis 487 of power screw 440. Power screw 440 and drive nut 458 define a threaded spindle drive assembly.

Power spring 468 is seated within toroidal chamber 482. Power spring 468 includes one end 490 engaging to second end 472 of extensible shaft 416, and another end 492 engaging to upper housing 414 adjacent lower housing 412. Power spring 468 is a coil spring that uncoils and recoils as extensible shaft 416 moves relative to upper 414 and lower 412 housings. It is, however, appreciated that the particular type of spring may vary.

In powered operation, torque provided by motor 442 is transferred via planetary gearset 446 to power screw 440 for causing linear motion of extensible shaft 416, as described above. For manual operation, motor 442 and planetary gearset 446 can be back driven and/or coupling 453 can releasably disconnect power screw 440 from gearset 446. The friction in the system due to the direct engagement of motor 442 and planetary gearset 446 with power screw 440 allows lift gate 12 to remain still in any intermediate position between the open and closed positions. Electromechanical biasing member 37 thus provides stable intermediate positions for the lift gate 12 (useful, for example, for garages with low ceilings) without power consumption by using the internal friction of motor-gearbox assembly 436. Electromechanical biasing member 37 can also include a motor sensor 493 (e.g., Hall-effect sensor) coupled to the motor 442 and to the actuator controller 50 to provide the position and/or speed of the motor 442.

Power spring 468 provides a mechanical counterbalance to the weight of lift gate 12. Power spring 468, which may be a coil spring, assists in raising lift gate 12 both in its powered and un-powered modes. When extensible shaft 416 is in the retracted position, power spring 468 is tightly compressed between extensible shaft 416 and lower housing 412. As power screw 440 rotates to extend shaft 416, power spring 468 extends as well for releasing its stored energy and transmitting an axial force through shaft 416 to help raise lift gate 12. When power screw 440 rotates to retract extensible shaft 416, or when lift gate 12 is manually closed, power spring 468 is compressed between shaft 416 and lower housing 412 and thus recharges.

In addition to assisting in driving power screw 440, power spring 468 also provides a preloading force for reducing starting resistance and wear of motor 442. Furthermore, power spring 468 provides dampening assistance when the lift gate 12 is closed. Unlike a gas strut, power spring 468 is generally not affected by temperature variations, nor does it unduly resist manual efforts to close the lift gate 12.

It is appreciated that a ball screw assembly, as known in the art, could be used in lieu of drive nut 458.

While the actuator system 220 has been described in association with lift gate 12, those skilled in the art will recognize that the actuator systems described herein can also be associated with any other closure panel of vehicle 10 such as doors 17. It is understood that the actuator assembly 37 shown associated with the lift gate 12 in FIGS. 1-4 and 9 and associated systems described herein could be provided elsewhere such that the actuator assembly 37 (e.g., counterbalance spring 468) is able to impart a balancing force to the lift gate 12 during opening and closing. It is understood that the closure panel actuation systems described herein could be associated with a hood, a frunk (“frunk trunk”), a side door closure system, such as for a gull wing or scissor type side door, as examples. The power closure panel actuation or actuator system shown in FIG. 2 is illustrated using two powered counterbalance struts or actuator assemblies 37 on opposite sides of the lift gate 12. Providing a dual powered counterbalance strut system ensures sufficient actuation force to move the lift gate 12 when operated in a haptic or powered assist mode by the user 275 as described in detail herein. Providing a dual powered counterbalance strut system ensures that the user 275 cannot manually move the lift gate 12 or other closure panel beyond the maximum rated speed/power output of the provided a dual powered counterbalance strut system during powered assist mode operation. Providing a powered counterbalance strut system that the user 275 cannot manually move the closure panel beyond the maximum rated speed/power output ensures the user 275 cannot manually move the lift gate 12, for example, above a speed at which the powered counterbalance strut system because to act as a brake against the movement of the lift gate 12. When the powered counterbalance strut or actuator system is acting as a brake against the motion of the lift gate 12 above a predetermined speed, such as above 55 degrees per second, the user 275 may sense the increase in resistance to motion of the lift gate 12 and a noticeable transition between a power assist mode and a braking mode of the powered counterbalance strut system. Thus, the powered counterbalance strut system maximum speed rating/power output is selected such that the user 275 cannot cause the powered counterbalance strut system to exceed its operating thresholds. While a single powered strut or actuator assembly 37 (with or without a counterbalance) may be provided capable of exceeding the target maximum threshold the user 275 can cause the powered counterbalance strut system to operate during the powered assist mode, using two powered counterbalance struts balances the limited packaging space available in a lift gate 12 closure configuration with the maximum speed rating/power output of the powered system. The powered counterbalance spindle or actuator assembly 37 may also be configured as a smart spindle, for example as shown in described in U.S. Pat. No. 10,774,571B2 titled “Integrated controller with sensors for electromechanical biasing member” and incorporated by reference in its entirety.

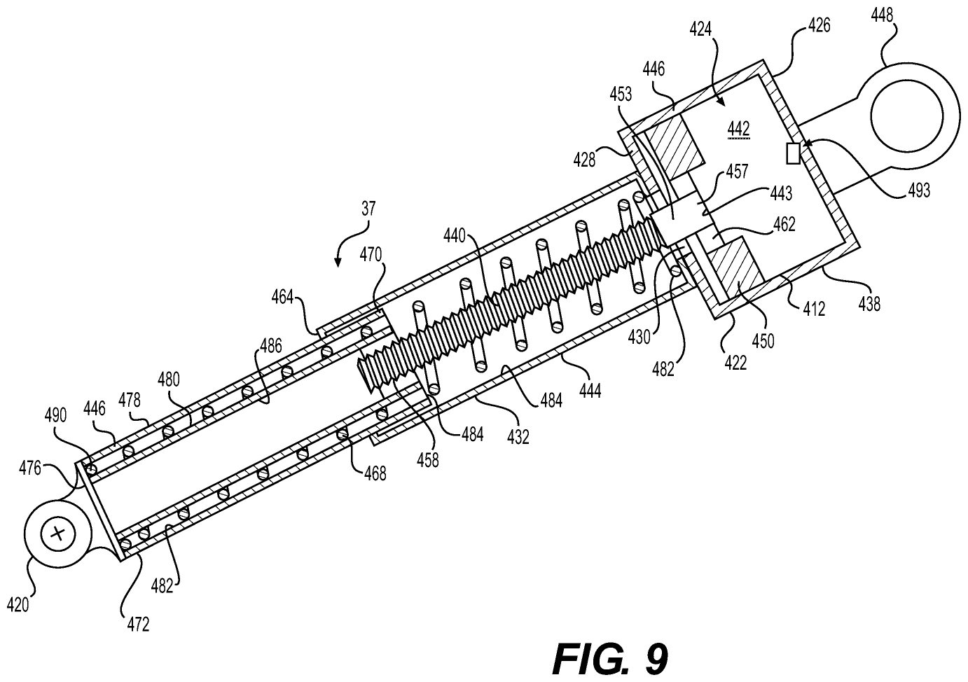

A power closure panel actuation system or actuator system 520 shown in FIG. 10 includes the actuator controller 50 configured as a master controller and configured to issue one or more actuations signals 50_{c} to actuate the motor 15, 142, 442 based on command control signals 508 (or also denoted as command signals 50ₑ) received via the electrical connection(s) 510 in order to move the closure panel 12 between the open position and the closed position. As such, the electrical connection(s) 510 would be used to supply a generic indication of an open or close command 508, as an example, issued from a vehicle control system 516, such as the BCM 52 (e.g., inputs 254, 256), or directly from an open/close switch (e.g. the key fob 260 over wireless link 563, an exterior closure panel handle, an interior closure panel handle, a smart latch 83, a latch controller, etc.) for receipt by the actuator controller 50 acting as the master controller. The command 508, such as an open or close command, would not be directly transmitted by the actuator controller 50 to the motor 15,142, 442 rather the actuator controller 50 would be responsible for processing the open/close command 508 and then generating additional actuation signals 50_{c} for direct consumption by the motor 15, 142, 442. In terms of master controller functionality, the actuator controller 50 operating as the master controller would be responsible for implementing control logic stored in a physical memory 50_{b}, 292 for execution by a data processor, such as processor 50ₐ, to generate the actuation signals 50_{c} (e.g. in the form of a pulse width modulated voltage for turning on and turning off motor 15, 142, 442 and controlling its direction and speed of output rotation of the power screw 440, in accordance with an illustrative example) to power the motor 15, 142, 442 in order to control its operation. As illustrated in FIG. 10, the actuator controller 50 is electrically coupled a motor driver 518 including field-effect transistors (FETSs) 50_{g} which are appropriately controlled (switched on/off) by the actuator controller 50 to generate the actuation signals 50_{c}. Circumstances surrounding the control of the motor 15, 142, 442 could include receiving sensor signals (via electronic components 264, 493 as sensors—e.g. position sensors, direction sensors, obstacle sensors, etc.) by the master controller as the actuator controller 50, processing those sensor signals, and adjusting operation of the motor 15, 142, 442 accordingly via new and/or modified actuation signals 50_{c} (e.g. adjust the period of PWM based actuation signals 50_{c} in the configuration where the motor 15, 142, 442 is responsive to supplied PWM signals). In this example, the sensor signals 50_{f} of sensors 264, 493 and the actuation signals 50_{c} are generated and processed internally in the actuator housing 412, 414 by the actuator controller 50, in conjunction with the motor 15, 142, 442 also mounted within the actuator housing 412, 414. As such, signals 508 could represent generic open/close signals, or other commands, coming from the handle(s), or other control system etc., while the actual actuation signals 50_{c} received by and consumed (i.e. processed) by the motor 15, 142, 442 would be generated by the actuator controller 50.

Still referring to FIG. 10, the integrated actuator controller 50 of the actuator assembly 37 and its interconnection with the various electronic components 50_{g}, 264, 493 is schematically represented. The actuator controller 50 can include a processor 50ₐ, 110 (e.g., a software module 500 or hardware modules 502 which may include a coprocessor or memory according to one embodiment) and a set of instructions 559 stored in the physical memory 50_{b}, 292 for execution by the processor 50ₐ, 110 to determine the actuation signals 50_{c} (for example, actuation signals in the form of a pulse width modulated voltage for turning on and turning off motor 15, 142, 442 and controlling its direction of output rotation) to power the motor 15, 142, 442 to control its operation in a desired manner. The memory 50_{b}, 292 may include a random access memory (“RAM”), read-only memory (“ROM”), flash memory, or the like for storing the set of instructions 559, and may be provided internal the processor 50ₐ, 110 or externally provided as a memory chip mounted to a printed circuit board (PCB), discussed in more detail below, or both. The memory 50_{b}, 292 may also store an operating system for general management of the actuator controller 50. As such, the electrical components 50_{g}, 264, 493 with the PCB(s) can be considered an embodiment of the control circuitry provided by the actuator controller 50 which operate together to form at least one computing device for processing data by a processor (e.g. processor 50ₐ, 110) such as communication signals, command signals 50ₑ, sensor signals 50_{f}, feedback signals 50ₕ and executing code or instructions stored in a memory (e.g. memory 50_{b}, 292) and outputting motor 15, 142, 442 control signals and for processing other communication/control signals and algorithms and methods in a manner as illustratively described herein.

Continuing to refer to FIG. 10, the actuator controller 50 can have a communication interface 50_{d} to receive any power and/or data/command signal(s)), such as receive control command signals 50ₑ from the electrical connection(s) 510 (issued by the remote/external control system 516) and in turn to control the operation of the motor 15, 142, 442 in response. The actuator controller 50 may optionally have a dedicated power interface 50ⱼ connected through electrical power signal line 506 to the power source or battery 53. Likewise, communication interface 50_{d} may be configured to supply power and/or data/command signal(s)), such as subcommand signals 50ᵢ to the electrical connection(s) 510 (for transmission to external systems 516 from the actuator assembly 37, when operating as a slave device). The communication interface 50_{d} may include one or more network connections adapted for communicating with other data processing systems (e.g., BCM 52, smart latch 83 in communication) over a vehicle network or bus via, and in the illustrative embodiment over the electrical connection(s) 510 which may form part of such as bus. For example, the communication interface 50_{d} may be connected to a Local Interconnect Network (LIN) or CAN bus or the like network protocol, over which command signals issued by the control system 516 over the vehicle network may be received and/or transmitted. As such, the communication interface 50_{d} may include suitable transmitters and receivers. Thus, the actuator controller 50 may be linked to other data processing systems by a communication network, which electrical connection(s) 510 may form part of. The communication interface 50_{d} may also be of a wireless configuration capable of sensing and transmitting communication signals wirelessly, for example using RF frequencies or the like, over wireless link 563. The input/output arrangements of the communication interface 50_{d} can be built into an I/O arrangement on the PCB(s) of the actuator controller 50 for integration within the actuator housing 412, 414. Optionally, it may be integrated into the microprocessor 50ₐ.

Command signals 50ₑ received by the communication interface 50_{d} may include data related a generic or high level command to open the closure panel 12 to a certain position; to hold the closure panel 12 at this position; to fully open the closure panel 12; to fully close the closure panel 12; as but a list of non-limiting examples of commands. For example, a generic “CLOSE” command received by the communication interface 50_{d} could result in the actuation signal 50_{c} to drive the motor 15, 142, 442 at certain speeds (e.g. the actuator controller 50 may control the switching frequency of FETS 50_{g} to adjust the power allowed to be conducted to the motor 15, 142, 442) over a defined path of movement from fully open, to a point/position before the fully close position where the actuation signal 50_{c} would be adjusted by the actuator controller 50 to reduce the speed of operation of the motor 15, 142, 442 (e.g. the actuator controller 50 may decrease the switching frequency of FETS 50_{g} to adjust the power allowed to be conducted to the motor 15, 142, 442) and stop movement of the closure panel 12 (e.g. the actuator controller 50 may control the FETS 50_{g} to stop conducting power to the motor 15, 142, 442) at a predefined point/position of the closure panel 12. For example, such a point may correspond to a position of the closure panel 12 whereat the latch 83 engages a striker (e.g., striker 44 of FIG. 2) provided on the vehicle body 11 where it is in an aligned position of with the striker to perform a cinching operation to thereby transition the closure panel 12 to the fully closed position without an operation of the motor 15, 142, 442, the cinching operation involving the transitioning of the latch 83 from a secondary latched position to a primary latched position as is generally known in the art. As a result, the striker provided on the closure panel 12 which is moved by the movement of the closure panel 12 into a position where the striker engages the secondary position of the latch 83 to capture and maintain the striker in latched engagement with the latch 83. At such a position, the motor 15, 142, 442 may be deactivated so as not to interfere with the cinching operation of the latch 83. Sensors provided in the latch 83 or in another remote system 516 and in communication directly or indirectly with the actuator controller 50, (for example via electrical connection(s) 510) may assist the actuator controller 50 to determine locally the actuation signal 50_{c} required to stop the motor 15, 142, 442 at this position. Illustratively, such sensors may be an accelerometer (e.g., accelerometer 697, discussed below), and may generate sensor signals to be communicated to the actuator controller 50 via the electrical connections 510. It is recognized that other command signals can be issued, such as to move the closure panel 12 from the fully opened to a secondary latching position whereat the vehicle latch 83 is moved into the secondary latched position in position for a cinching operation to transition the latch 83 from the secondary position to the primary latched position, and for other closure panel movement operations. The processor 50ₐ, 110 can therefore be programmed to execute instructions as a function of the command signals 50ₑ transmitted and received by the communication interface 50_{d} as Local Interconnect Network protocol signals such as but not limited to commands for operating the actuator assembly 37 in a mode of operation including: a position request for motion mode, a push to close command mode, a push to open command mode, a time detected obstacle mode, a zone detected obstacle mode, a full open position detected mode, a learn mode, and/or an adjustable stop position mode.

Still referring to FIG. 10, the actuator controller 50 is configured to interpret the command signals 50ₑ received at the communication interface 50_{d} from the external or remote system 516 and in response activate the motor driver 518 including the FETS 50_{g} appropriately, for example based on a stored movement sequence or profile stored in memory 50_{b}, 292 and referenced (e.g. looked up in memory 50_{b}, 292) based upon, at least in part, the received command signals 50ₑ. Such predefined stored movement sequences of the closure panel 12 may be recorded in the memory 50_{b}, 292. For example, the received command signals 50ₑ may be a digital message encoded according to a communication protocol (e.g. a serial binary message-based protocol), the actuator controller 50 capable of decoding the digital message to extract the command (e.g. converts the data stream received by the communication interface 50_{d} as serial bits (voltage) levels into data that the actuator controller 50 can process). In response, actuator controller 50 may issue FET control signals to control the operation of the FETs 50_{g} (e.g. control the FET gates) to supply current and/or voltage to the motor 15, 142, 442.

The actuator controller 50 can be further programmed by the execution of instructions 559 to operate the motor 15, 142, 442 based on different desired operating characteristics of the closure panel 12. For example, the actuator controller 50 can be programmed to open or close the closure panel 12 automatically (i.e. in the presence of a wireless transponder (such as a wireless key FOB 260) being in range of the communication interface 50_{d}) when a user outside of the vehicle 10 initiates an open or close command of the closure panel 12. Also, the actuator controller 50 can be programmed to process feedback signals 50_{f} from the electronic sensors 264, 493 supplied to the actuator controller 50 to help identify whether the closure panel 12 is in an opened or closed position, or any positions in between. Further, the closure panel 12 can be automatically controlled to close after a predefined time (e.g. 5 minutes) or remain open for a predefined time (e.g. 30 minutes) based on the instructions 559 stored in the physical memory 50_{b}, 292. For example, the high level generic command (e.g. 50ₑ) may include a command labelled, for illustrative purposes only: “Open Profile A”, which may be decoded by the actuator controller 50 to undertake operation of the actuator assembly 37 to move the closure panel 12 in accordance with a sequence of operations as stored in memory 50_{b}, 292 including three aspects such as moving the closure panel 12 to fully open position, a hold open for a period of time (e.g., 3 minutes) after the closure panel 12 has reached the fully opened position, and a fully closing operation after a second period of time (e.g., 5 minutes) after the closure panel 12 has reached the fully opened position. For example, the high level generic command (e.g. 50ₑ) may include a command labelled “Open Profile B”, which may be decoded by the actuator controller 50 to undertake similar operations of “Open Profile A” except replacing the fully closing operation with an expected manual user movement of the closure panel 12 as would be detected by the sensors 264, 493. Further, the processor 50ₐ, 110 can be programmed to execute the instructions complementing and enhancing the functionality of the closure panel 12 locally of received profile command, for example executing a sub-profile operating mode, based on received signals 50_{f} from the electric motor 15, 142, 442 representative of an electric motor 15, 142, 442 operation selected from operations such as but not limited to: an electric motor speed ramp up and ramp down operating profile, an obstacle detecting mode for detecting obstructions of the pivotal closure panel between an open position and a closed position, a falling pivotal closure panel detection mode, a current detection obstacle mode, a full open position mode, a learn completed mode, a motor motion mode, and/or an unpowered rapid motor motion mode.

As another illustrative example of locally controlled operation of the actuator assembly 37, a manual override function is described. As discussed above, one or more Hall-effect sensors 264, 493 may be provided and positioned within actuator housing 264, 493, for example, and discussed in more detail below, the Hall-effect sensors 264, 493 are positioned on a printed circuit board adjacent to the motor shaft 443, to send a signal, such as an analog voltage time varying signal depending of the change in magnetic field detected by the Hall-effect sensors 264, 493, representative of operation (e.g., rotation(s) of the driven shaft 166) of the electric motor 15, 142, 442 to actuator controller 50 that are indicative of rotational movement of motor 15, 142, 442 and indicative of the rotational speed of motor 15, 142, 442, e.g., based on counting signals from the Hall-effect sensor 264, 493 detecting a target (e.g., magnet wheel 180) on the driven shaft 166. In situations where the sensed speed of the motor 15, 142, 442 is greater than a prestored expected threshold speed, stored in memory 50_{b}, 292 for example, and where a current sensor (in the case where ripple counting is employed to determine the operation of the motor 15, 142, 442, such as to determine the position of the motor 15, 142, 442) registers a significant change in a current draw, the actuator controller 50 may determine that a user is manually moving the closure panel 12 while motor 15, 142, 442 is also operating to rotate the lead screw 134, thus moving the closure panel 12 between its opened and closed positions. The actuator controller 50 may then send in response to such a determination the appropriate actuation signals 50_{c} (by cutting the power flow to the motor 15, 142, 442 for example) resulting in the motor 15, 142, 442 to stop to allow a manual override/control of the closure panel 12 by the user 275. Conversely, and as an example of an object or obstacle detection functionality, when the actuator controller 50 is in a power open or power close mode and the Hall-effect sensors 264, 493 indicate that a speed of the motor 15, 142, 442 is less than a threshold speed (e.g., zero) and a current spike is detected (in the case where ripple counting is employed to determine the operation of the motor 15, 142, 442), the actuator controller 50 may determine that an obstacle or object is in the way of the closure panel 12, in which case the actuator controller 50 may take any suitable action, such as sending an actuation signal 50_{c} to turn off the motor 15, 142, 442, or sending an actuation signal 50_{c} to reverse the motor 15, 142, 442. As such, the actuator controller 50 receives feedback from the Hall-effect sensors 264, 493, or from a current sensor (not shown) and renders control decisions locally for the actuator assembly 37 to ensure that a contact or impact with the obstacle and the closure panel 12 has not occurred during movement of the closure panel 12 from the closed position to the opened position, or vice versa. An anti-pinch functionality may also be performed in a similar manner to the obstacle detection functionality, to particularly detect an obstacle such as a limb or finger is present between the closure panel 12 and the vehicle body 11 about the nearly fully closed position during the closure panel 12 transition towards the fully closed position.

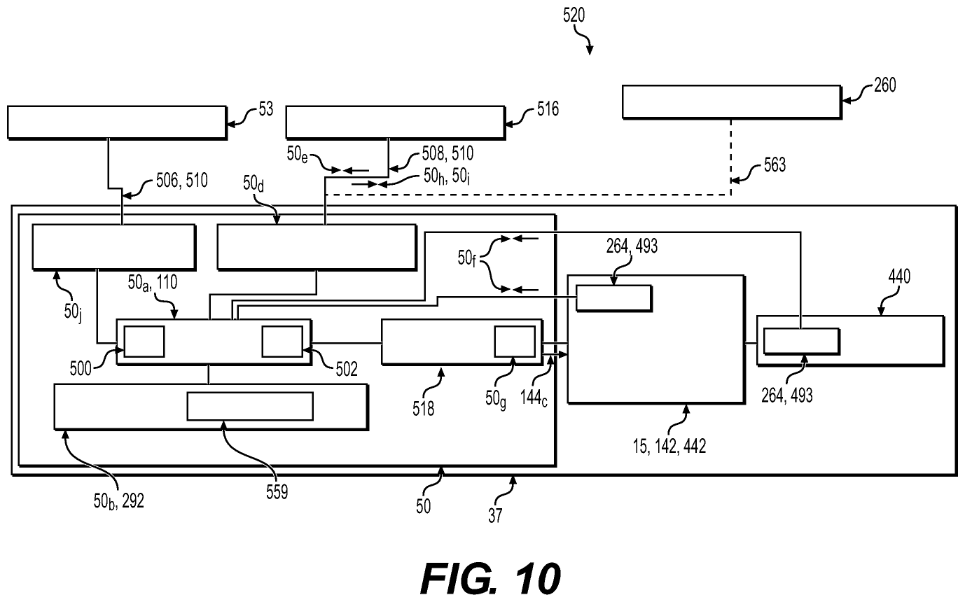

Now further referring to FIG. 11, there is shown a configuration of controller 50 configured for controlling the motor 15, 142, 442 using a closed loop current feedback motor control system 601 to supply the motor 15, 142, 442 with a drive current I. Controller 50 may also include a haptic control algorithm 602 configured for determining a torque value or target torque T_{target} the motor 15, 142, 442, controlled by the closed loop current feedback motor control system 601, will apply to the closure panel 12. A drive unit 604 may be provided that is configured to convert the torque value outputted by the haptic control algorithm 602 into a target current I_{target} for input into the closed loop current feedback motor control system 601. An example of the haptic control algorithm 602 is described in WO2021081664A1 entitled “Powered door unit optimized for servo control”, the entire contents of which are incorporated herein by reference.

So, closed loop current feedback motor control system 601, haptic control algorithm 602, drive unit 604, and motor 15, 142, 442 may work together as part of a motor control or actuator system 600 for controlling motion of the lift gate 12. In more detail, the system 600 can include the motor 15, 142, 442 for moving the lift gate 12. The system 600 can also include the closed loop current control system 601 controlling the drive current I provided to the motor 15, 142, 442 for controlling the motor 15, 142, 442 to apply a torque T to the lift gate 12. The system 600 also includes the haptic control algorithm 602 configured for calculating a target torque T_{target} to be provided to the closed loop current control system 601. The closed loop current control system 601 controls the drive current I based on the target torque T_{target}.

Controlling the motor 15, 142, 442 using a closed loop current feedback motor control system 601 receiving a control command calculated based on torque values improves the performance of the closure panel control by the motor 15, 142, 442. Since the drive current I provided to the motor 15, 142, 442 is controlled via the closed loop feedback system 601, and since drive current I is proportional to motor torque output T (or alternatively considering from a reference point of a user causing a torque input on the motor 15, 142, 442 via the user moving the lift gate 12, whereby the motor 15, 142, 442 will act as a torque input generator to proportionally modify the drive current I). So, fast response times and accurate torque response when driving the lift gate 12 is achieved by using a current-based approach for controlling the motor 15, 142, 442. Desired torque T to be applied on the lift gate 12 by the motor 15, 142, 442 is achieved by using closed loop current feedback motor control system 601, such that target torque input T_{target} is converted into a target current value I_{target} to control the motor 15, 142, 442. Since motor current I is proportional to the motor torque T, controlling the current I based on the haptic torque target T_{target} will result in an accurate conversion of the target compensation torque applied to the lift gate 12 by the motor 15, 142, 442 through control of the motor current I.

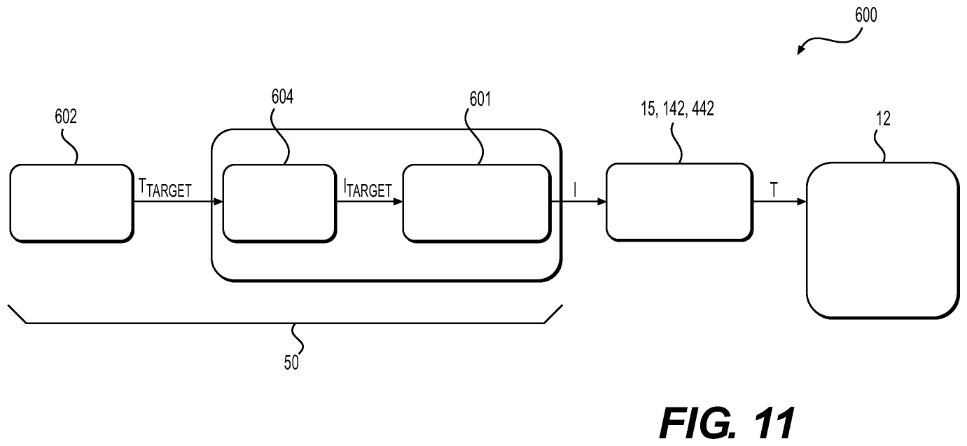

Now further referring to FIG. 12, there is shown a block diagram illustrating various sensors provided to the various control blocks of the motor control system 50. The system 600 also includes a current sensor 606 for detecting a sensed current I_{sensed} flowing in the motor 15, 142, 442. The haptic control algorithm 601 is further configured to receive the sensed current I_{sensed} and calculate the target torque T_{target}. Thus, the current sensor 606 providing accurate torque values to the haptic control algorithm 602 and an accelerometer 697 (and closure panel position sensors 264, 493 discussed above and in more detail below) are provided for operating the closed loop current feedback motor control system 601.

Specifically, the accelerometer 697 may provide more sensitive sensing of closure panel motion and output an acceleration signal 698, while the closure panel position sensors 264, 493 may be provided to indicate a door position 265 and/or a motor position 494, respectively, to offer reliability of closure panel position and motion to the system 50. In other words, an accelerometer sensitivity of the accelerometer 697 is greater than a position sensitivity of a closure panel position sensor 264, 493, such that the accelerometer 697 detects motion that is not detectable by the closure panel position sensor 264, 493. The acceleration signal 698 is provided to the drive unit 604 and to the haptic control algorithm 602 for inertia torque calculations. Consideration of the acceleration signal 698 by the drive unit 604 provides increased sensitivity/resolution to lift gate 12 movements by a user compared to the using position signals 265, 494 alone, thereby providing faster system response. Therefore, different sensors may provide accurate, reliable, and sensitive data for providing feedback of closure panel motion in control system 600.

So, the force based control of the motor 15, 142, 442 will be improved by using the current sensor 606 (e.g., a shunt resistor configuration) detecting the current from the motor 15, 142, 442 through the return feedback branch of closed loop current feedback motor control system 301 for example, directly measuring the current running through the motor 15, 142, 442 as modified by the user pushing on the lift gate 12 to cause the motor 15, 142, 442 to act as a generator provides a derivable torque value for use by the haptic control algorithm 602. By monitoring the drive current I directly, the haptic control algorithm 602 can be inputted a precise input torque (via the proportional to the sensed current I_{sensed}) applied by the user on the lift gate 12. Compared to other types of sensors such as closure panel position sensors or accelerometer 697, such sensors cannot detect the force input on the lift gate 12 and would require a transfer function to translate the position or motion signals into an approximate force value. By detecting the sensed current I_{sensed} flowing through the motor 15, 142, 442, since such drive current I is proportional to the torque T of the motor 15, 142, 442, such detected or sensed current I_{sensed} can be fed back to the haptic control algorithm 602 to modify the target torque T_{target} to be provided to the drive unit 604. Since the haptic control algorithm 602 performs calculations in terms of torque values, and the detect motor current can be easily translated into torque values to be used by the haptic control algorithm 602, other sensors such as position sensors, accelerometer 697 in comparison which require complex conversions from position/velocity/acceleration data into torque, may also further be unable to provide data or accurate data to extract force acting on the lift gate 12 for use by the haptic control algorithm 602. Therefore, using a closed loop current feedback motor control system 601 where the current in the feedback line from the motor 15, 142, 442 is sensed to be used by the haptic control algorithm 602 to provide data that is correlated to the exact torque the user is applying to the lift gate 12, results in a precise Torque Output Target from the haptic control algorithm 602 to be supplied to the drive unit 604 which the closed loop current feedback motor control system 601 will in turn use to adjust the motor torque acting on the lift gate 12 and which will be sensed by the user. Therefore the force of the user acting on the lift gate 12 can be precisely compensated by the haptic control algorithm 602 since the user's force can be precisely detected by detecting the motor current. Thus, improvements in torque response of the motor 15, 142, 442 on the lift gate 12, as well as accurate position data used by the drive unit 604 is achieved by the drive unit 604 considering motion data of the lift gate 12 provided by the accelerometer 697 for providing sensitivity the position sensors 264, 493 alone cannot provide, while the drive unit 604 also considers motion data of the lift gate 12 provided by the position sensors 264, 493, which provide reliable door position information 265, 494 the accelerometer 697 cannot provide alone. To ensure that the closed loop current system 600 does not act against a user manually moving the lift gate 12, the drive unit 604 also considers sensed bidirectional motor current I_{sensed} and adjusts the I_{target} accordingly.

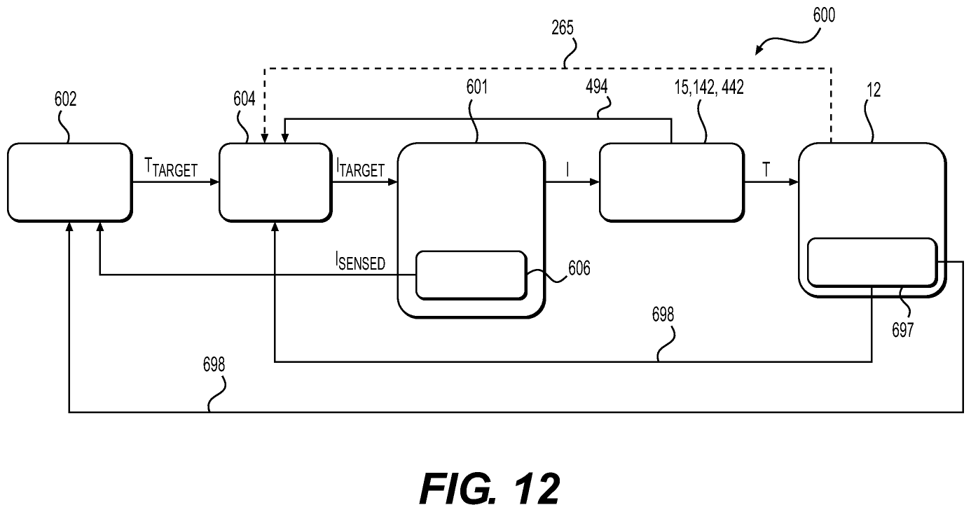

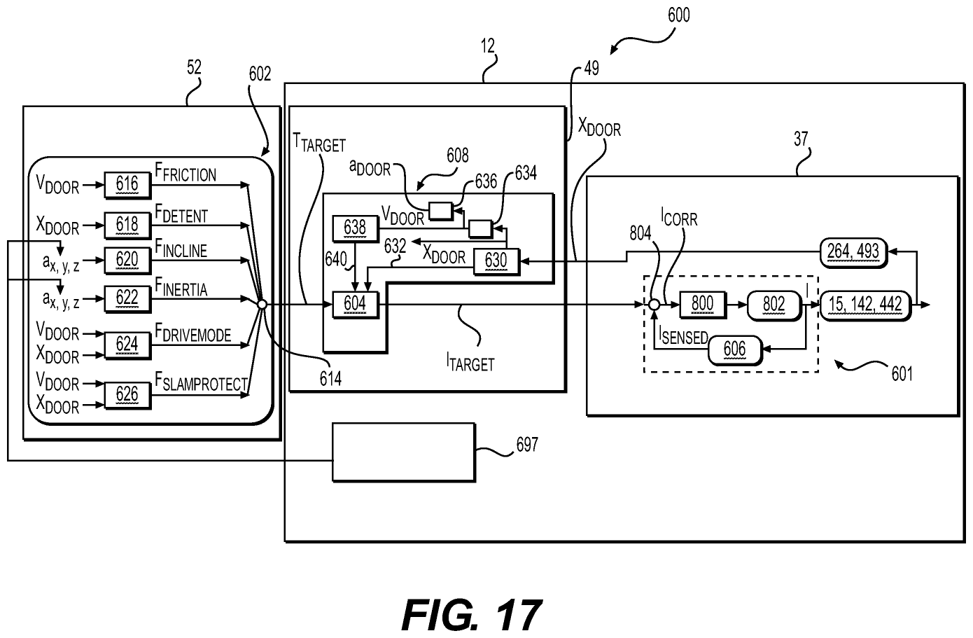

Now further referring to FIG. 13, the closed loop current feedback motor control system 601 and the motor controller 608 comprising the drive unit 604 and the closed loop current feedback motor control system 601 may be distributed in various manners as shown in FIG. 17, for example. Separation of the haptic control algorithm 602 from the motor controller 608 and the closed loop current feedback motor control system 601 provides for separation of control component between components which are dynamic, for example which require more frequent updates, maintenance, tuning, from those components which are static, for example those which do not require updates, or maintenance. For example, the haptic control algorithm 602 can be updated regularly with new functions, modules, and control features depending on the vehicle application, or depending on subsequent tuning of the system, or with additional improvements in the algorithm. As a result the haptic control algorithm 602 may be provided as part of a centralized vehicle controller, such as the BCM 52 (FIG. 17), which is configured for ease of upgradability, such as via flashing or uploading as part of a regular system update, or as part of a dedicated update of the haptic control algorithm 602. So, the haptic control algorithm 602 can be provided as part of the centralized vehicle controller (e.g., BCM 52) not in the lift gate 12, while the closed loop current control system 601 can be provided within the lift gate 12. Furthermore, the haptic control algorithm 602 may involve computationally intense computations requiring access to a powerful processor, and as a result the haptic control algorithm 602 may be distributed into the memory of separate main vehicle controller comprising such a powerful processor also used for controlling other system e.g. such as a ADAS system. Whereas low level feedback motor control system 601 and motor controller 608 may be static and not require regular or any updates, and may be provided in less accessibly parts of the vehicle 10. For example, if the motor controller 608 is provided in the electromechanical biasing member 37, an updating communication port may be removed as compared to if the haptic control algorithm 602 is also provided with the electromechanical biasing member 37. In addition, the closed loop current control system 601 may comprise a memory unit that cannot be overwritten, while the haptic control algorithm 602 comprises a memory that can be overwritten.

Referring specifically to FIG. 13, the accelerometer 697 provides an acceleration signal a_{x,y,z} (i.e., acceleration signal 698) to at least one of the closed loop current control system 601 and the haptic control algorithm 602. The haptic control algorithm 602 includes a summation of a plurality of forces from a plurality of force calculations 616, 618, 620, 622, 624, 626 by a summer 614 that outputs the target torque T_{target} to the drive unit 604. The plurality of force calculations include a friction force calculation 616 that receives a velocity of the door or lift gate 12 v_{door} input and outputs a friction force F_{friction}, a detent force calculation 618 that receives a position of the door or lift gate 12 x_{door} input and outputs a detent force F_{detent}, an incline force calculation 620 that receives the acceleration signal a_{x,y,z} input and outputs an incline force F_{incline}, an inertia force calculation 622 that receives the acceleration signal a_{x,y,z} input and outputs an inertia force Fᵢₙₑᵣₜᵢₐ, a drive mode force calculation 624 that receives the position of the door or lift gate 12 x_{door} and the velocity of the door of lift gate 12 v_{door} input and outputs a drive mode force F_{drivemode}, a slam protect force calculation 626 that receives the position of the door or lift gate 12 x_{door} and the velocity of the door or lift gate 12 v_{door} input and outputs a slam protect force F_{slamprotect}.

The closure panel position sensors 264, 493 are coupled to a kinematic block 630 configured to receive the position of the door or lift gate 12 x_{door} and output a first force input 632 to the drive unit 604. The kinematic block 630 is also coupled to a first differentiator 634 configured to mathematically differentiate the position of the door or lift gate 12 x_{door} and output the velocity of the door or lift gate 12 v_{door}. The first differentiator 634 is then coupled to a second differentiator 636 configured to mathematically differentiate the velocity of the door or lift gate 12 v_{door} and output an acceleration of the door or lift gate 12 a_{door}. The velocity of the door or lift gate 12 v_{door} is received by a backdrive block 638 that is configured to receive the velocity of the door or lift gate 12 v_{door} and output a second force input 640 to the drive unit 604. The drive unit 604 receives the first and second force inputs 632, 640 and outputs the target current I_{target}.

The closed loop current control system 601 includes a motor block 800 connected to an H-bridge block 802. A subtractor 804 subtracts the sensed current I_{sensed} from the current sensor 606 from the target current I_{target} to output a corrected current I_{corr} to the motor block 800. The motor block 800 and H-bridge block 802 are configured to convert the corrected current I_{corr} to the drive current I which is sensed by the current sensor 606.

Still referring to FIG. 13, the haptic control algorithm 602 is shown adapted for using with a lift gate having a counterbalance mechanism (e.g., power spring 468 of FIG. 9) acting on the lift gate 12, such as using the powered counterbalance strut or electromechanical biasing member 37 shown in FIGS. 2, 4, and 9. The haptic control algorithm 602 is adapted to compensate for the counterbalance mechanism providing a force on the lift gate 12, such as an assist force against the force of gravity acting on the closure panel as a lift gate 12. For example the counterbalance or power spring 468 may provide for a force assisting the lift gate 12 motion towards the open position and may provide a resistive force (hold open force) against the motion of the lift gate 12 towards the close position. The haptic control algorithm 602 is thus adapted to compensate for an external force on the lift gate 12 that is different depending on the direction of the motion of the lift gate 12. A counterbalance spring module 627 may for example be provided as part of the haptic control algorithm 602 that is configured to generate a torque value counteracting the effect of the counterbalance spring 468 such that the lift gate 12 may be controlled in a similar manner as that of a side powered swing door (e.g., door 17). The incline unit 620 of haptic control algorithm 602 applied to a lift gate 12 closure panel registers an inclination of the lift gate 12 not only when the vehicle 10 is on a grade or inclination due to the lift gate 12 orientation compared to a side door. Due to such constant detected inclination of the lift gate 12, incline unit 620 will generate an appropriate compensating torque output value. To compensate for the counterbalance effect on the lift gate 12, the counterbalance spring module 627 is adapted to negate the inclination due to the lift gate 12 orientation by output a negative torque value into the summation block 614. In accordance with the superposition principle, the torque output (Ttarget) to be provided to the motor control system 601 will be a compensated value for the counterbalance spring 468. As a result the motor 15, 142, 442 will be driven to output a value adjusted to any inclination of the vehicle 10 affect the orientation of a lift gate 12 configuration and the motor 15, 142, 442 will not be overdriven compared to a lift gate 12 not provided with a counterbalance spring 468 (e.g., the electromechanical biasing member shown in FIG. 4).

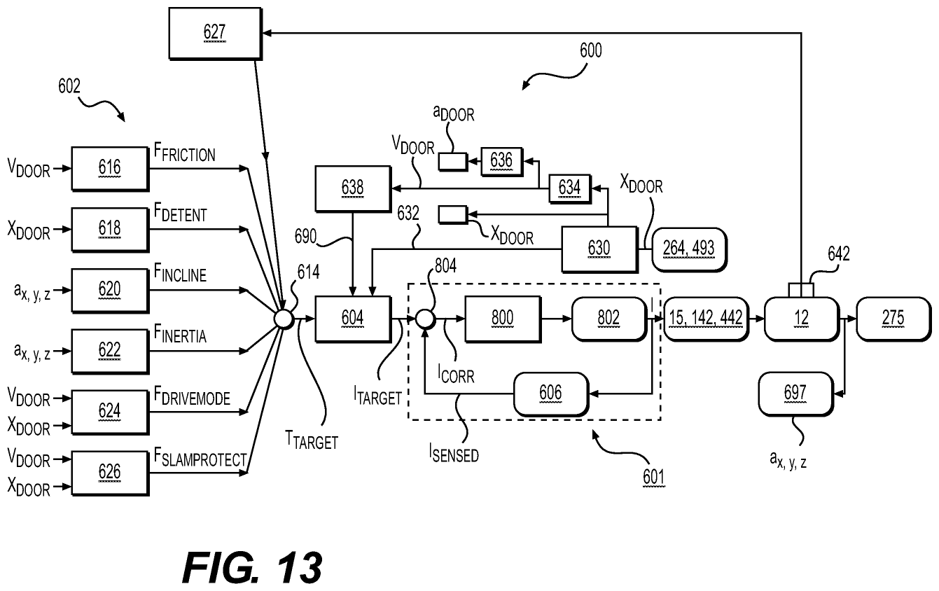

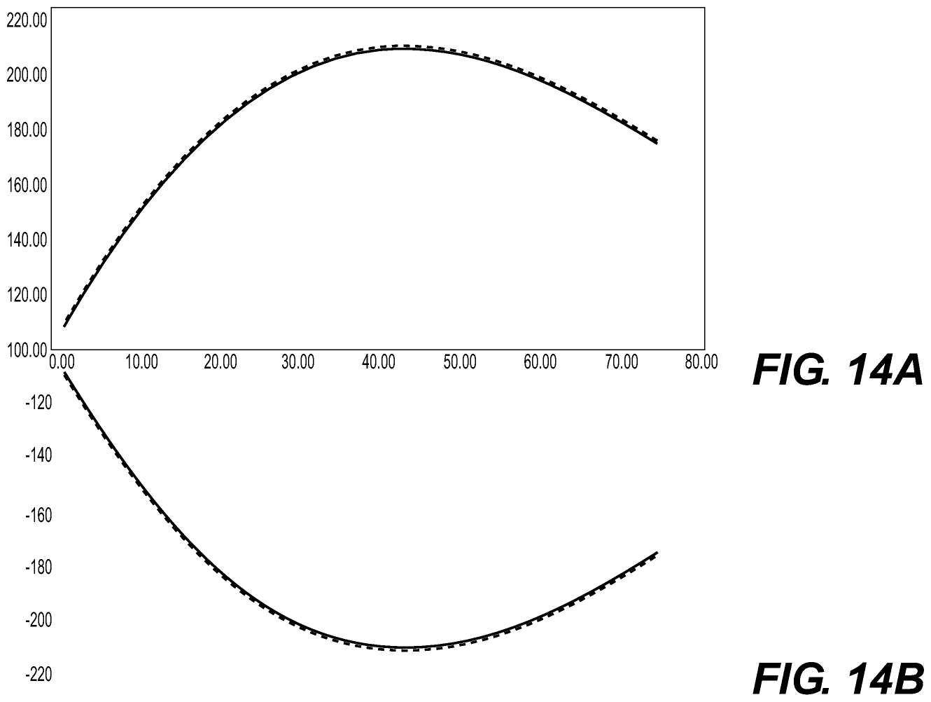

Now further referring to FIGS. 14A and 14B, the counterbalance spring module 627 is illustratively adapted to receive a position of the lift gate 12 relative to the vehicle body 11, for example receive a signal from an absolute position sensor 642 (FIG. 13), and generate a compensating force that is opposite the force of the counterbalance spring 468 as a function of the angle of the lift gate 12. As shown in FIG. 14A is a predetermined counterbalance spring output force at a given angle of the lift gate 12, and as shown in FIG. 14B is compensating force output of the counterbalance spring module 627 as a function of the position of the lift gate 12.

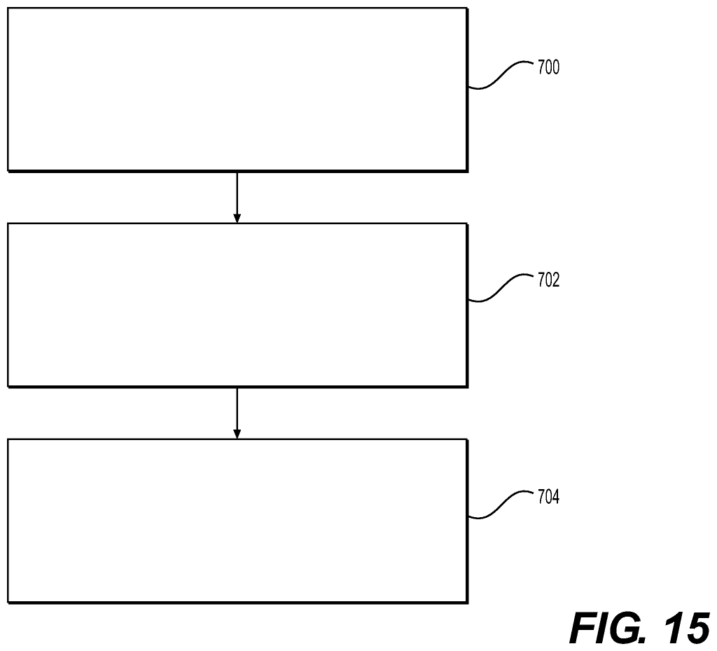

Now referring to FIG. 15, an illustrative method of generating a counterbalance spring output force as may be executed by the counterbalance spring module 627 is shown, including the step of 700 determining the position of the lift gate 12. Next, 702 determining a force that negates the effect of a counterbalance mechanism (e.g. spring 468) acting on lift gate 12. The method also includes the step of 704 adjusting the target compensation force to be provided to the motor 15, 142, 442 using the force that negates the effect of the counterbalance mechanism acting on the lift gate 12.

So, as discussed above, the actuator system 220, 520, 600 for the closure panel 12 (e.g., lift gate 12) of the vehicle 10 includes a biasing member (e.g., power or counterbalance spring 468) adapted to apply a biasing member force to the closure panel 12. The actuator system 220 520, 600 also includes the electromechanical biasing member or actuator assembly 37 comprising an actuator housing 412, 414. The actuator assembly 37 additionally includes the motor 15, 142, 442 disposed in the actuator housing 412, 414 and configured to rotate the motor shaft 443 operably coupled to the extensible member 416 coupled to one of the body 11 and the closure panel 12 for opening or closing the closure panel 12. According to aspects of the disclosure, the actuator controller 50 is configured to control the motor 15, 142, 442 to output an adjusted force based on the biasing member force to move the closure panel 12. In more detail, the actuator controller 50 is further configured to determine a position of the closure panel 12 and determine a force that negates an effect of a counterbalance mechanism 468 acting on the closure panel 12. The actuator controller 50 is additionally configured to adjust a target compensation force to be provided to the motor 15, 142, 442 using the force that negates the effect of the counterbalance mechanism 468 acting on the closure panel 12.

According to other aspects of the disclosure, the actuator controller 50 is further configured to hold the closure panel (e.g., lift gate 12) in a third position/intermediate position between fully opened and fully closed. Thus, the actuator controller 50 is configured to determine a stop position of the lift gate 12. The determining the stop position of the lift gate 12 may include determining no motion of the lift gate 12 by a user 275. The actuator controller 50 is also configured to determine whether the lift gate 12 has been stopped at an unbalanced position at which the biasing member 468 coupled to the lift gate 12 does not fully balance of the lift gate 12. The actuator controller controls the motor 15, 142, 442 to hold the lift gate 12 at the stopped position to prevent sag of the lift gate 12 away from the stopped position. The sag of the lift gate 12 can occur in response to the motor 15, 142, 442 not providing an additional lifting force of the lift gate 12 in the unbalanced position.

In addition, the actuator controller 50 is configured to start a thermal timer and control the motor 15, 142, 442 to allow the lift gate 12 to move to a steady state position after expiry of a thermal time out. The thermal timer may, for example, be a predetermined time period calculated using an estimated temperature of the motor 15, 142, 442 based on a detected current draw to the motor 15, 142, 442 during a hold operation of the motor 15, 142, 442 and an ambient temperature in which the vehicle 10 is located. The biasing member 468 fully supports the lift gate 12 at the steady state position without assistance from the motor 15, 142, 442.

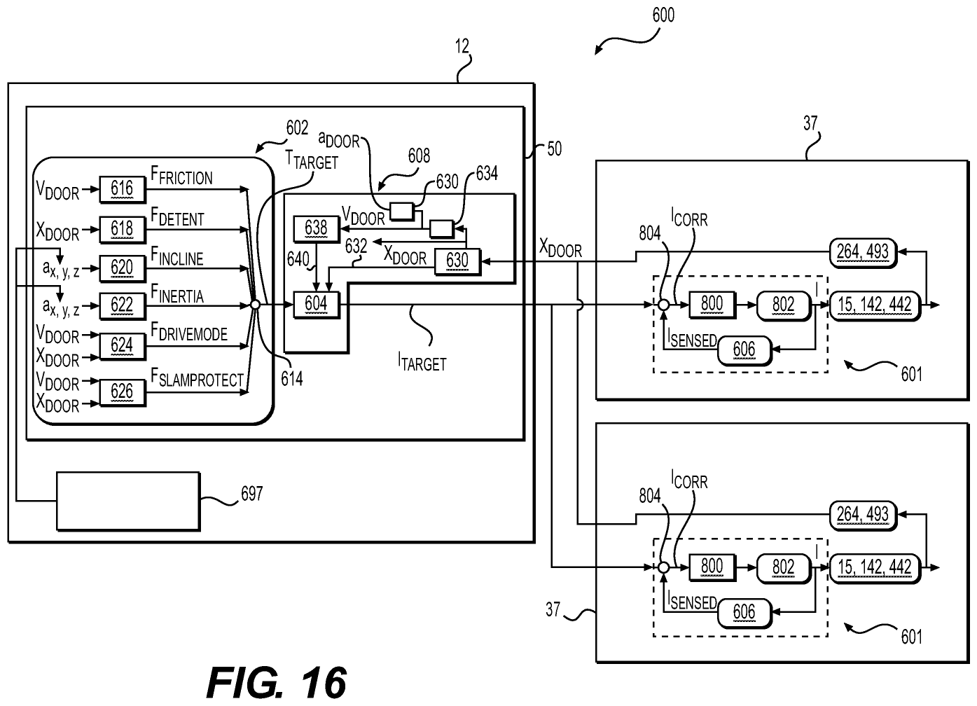

Now referring specifically to FIG. 16, the kinematic block 630, first differentiator 634, second differentiator 636, backdrive block 638 and drive unit 604 may comprise the motor controller 608 of controller 50. In further detail, FIG. 16 shows the haptic control algorithm 602 provided in a remote controller (e.g., controller 50 or latch assembly 83) within the lift gate 12, separate from the electromechanical biasing member 37. Specifically, the haptic control algorithm 602 and motor controller 608 are provided in the remote controller (e.g., controller 50) within the lift gate 12. The electromechanical biasing member or actuator assemblies 37 each include the closed loop current feedback motor control system 601, motor 15, 142, 442, and closure panel position sensor 264, 493. Also, as shown, accelerometer 697 is separate or remote from the electromechanical biasing members 37, while still being coupled to the haptic control algorithm 602.

In further detail, FIG. 17 shows the haptic control algorithm 602 provided in a remote controller not within the lift gate 12, such as provided as part of the Body Control Module 52 (BCM). Since Body Control Module already includes communication access ports/interface for receiving updates, the haptic control algorithm 602 may be easily and repeatability updated, for example by flashing, using this communication interface. The closure panel node assembly 49 includes the motor controller 608. The electromechanical biasing member 37 includes the closed loop current feedback motor control system 601, motor 15, 142, 442, and closure panel position sensor 264, 493. The accelerometer 697 is disposed remotely from the BCM 52, closure panel node assembly 652, and actuator assembly or electromechanical biasing member 37.

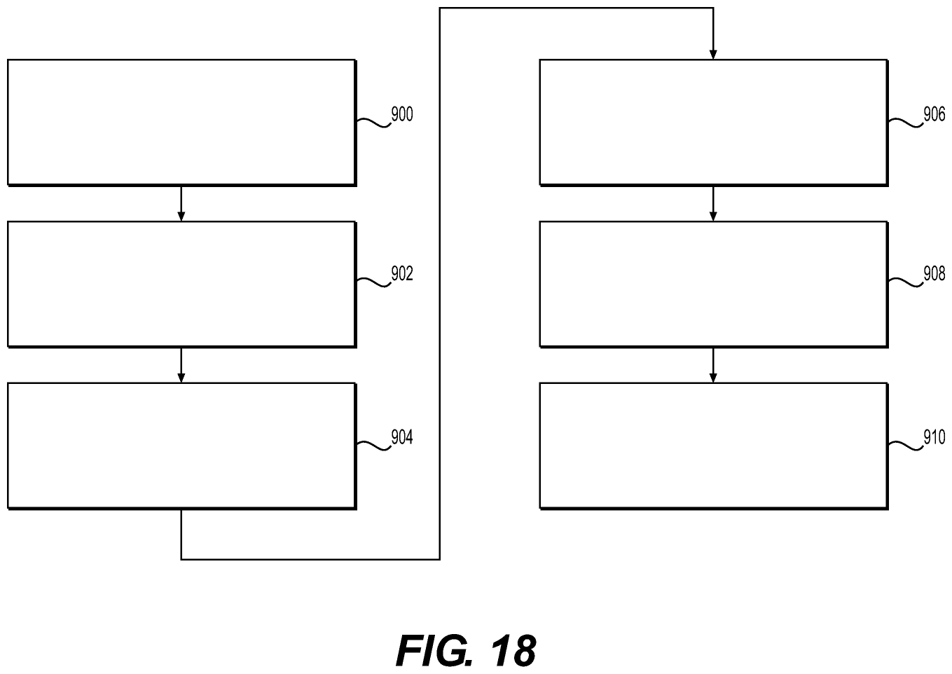

Now referring to FIG. 18, there is shown a method of holding a closure panel (e.g., lift gate 12) in a third position/intermediate position between fully opened and fully closed, which could be executed by the actuator controller 50. The method includes the step of 900 determining a position of the lift gate 12. The method also includes the step of 902 determining a stop position of the lift gate 12. According to an aspect, the step of 902 determining the stop position of the lift gate 12 includes determining no motion of the lift gate 12 by a user 275. The method continues with the step of 904 determining whether the lift gate 12 has been stopped at an unbalanced position at which a biasing member 468 coupled to the lift gate 12 does not fully balance of the lift gate 12. Next, 906 controlling the motor 15, 142, 442 to hold the lift gate 12 at the stopped position to prevent sag of the lift gate 12 away from the stopped position. According to another aspect, the sag of the lift gate 12 occurs in response to the motor 15, 142, 442 not providing additional lifting force of the lift gate 12 in the unbalanced position. The method continues by 908 starting a thermal timer. The thermal timer can be a predetermined time period calculated using an estimated temperature of the motor 15, 142, 442 based on a detected current draw to the motor 15, 142, 442 during a hold operation of the motor 15, 142, 442 and an ambient temperature in which the vehicle 10 is located. The thermal timer helps determine when the motor 15, 142, 442 should be disabled so as not to allow the motor 15, 142, 442 to overheat. According to an aspect, the motor 15, 142, 442 may be shut off, or the motor 15, 142, 442 may operate in a dynamic brake mode to allow the lift gate 12 to move to a steady state position in a safe and controlled manner. Thus, the method additionally includes the step of 910 controlling the motor 15, 142, 442 to allow the lift gate 12 to move to the steady state position after expiry of a thermal time out. In the steady state position, the counterbalance mechanism 468 fully supports the lift gate 12 without assistance from the motor 15, 142, 442. Again, the counterbalance mechanism 468 can comprise a counterbalance spring 468 adapted to apply a biasing member force to the closure panel 12.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An actuator system for a closure panel of a vehicle comprising:
a biasing member adapted to apply a biasing member force to the closure panel;
an actuator assembly comprising:
an actuator housing, and
a motor disposed in the actuator housing and configured to rotate a motor shaft operably coupled to an extensible member coupled to one of a body and the closure panel for opening or closing the closure panel; and
an actuator controller configured to control the motor to output an adjusted force based on the biasing member force to move the closure panel.

2. The actuator system as set forth in claim 1, wherein the biasing member comrises a counterbalance spring.

3. The actuator system as set forth in claim 1, wherein the actuator controller is further configured to:
determine a position of the closure panel;
determine a force that negates an effect of a counterbalance mechanism acting on the closure panel; and
adjust a target compensation force to be provided to the motor using the force that negates the effect of the counterbalance mechanism acting on the closure panel.

4. The actuator system as set forth in claim 1, wherein the closure panel is a lift gate and the actuator controller is further configured to:
determine a stop position of the lift gate;
determine whether the lift gate has been stopped at an unbalanced position at which the biasing member coupled to the lift gate does not fully balance of the lift gate;
control the motor to hold the lift gate at the stopped position to prevent sag of the lift gate away from the stopped position;
start a thermal timer; and
control the motor to allow the lift gate to move to a steady state position after expiry of a thermal time out.

5. The actuator system as set forth in claim 4, wherein the determining the stop position of the lift gate includes determining no motion of the lift gate by a user.

6. The actuator system as set forth in claim 4, wherein the sag of the lift gate occurs in response to the motor not providing an additional lifting force of the lift gate in the unbalanced position.

7. The actuator system as set forth in claim 4, wherein the thermal timer is a predetermined time period calculated using an estimated temperature of the motor based on a detected current draw to the motor during a hold operation of the motor and an ambient temperature in which the vehicle is located.

8. The actuator system as set forth in claim 4, wherein the biasing member fully supports the lift gate at the steady state position without assistance from the motor.

9. A method of operating an actuator system of a vehicle comprising the steps of:
determining a position of a closure panel;
determining a force that negates an effect of a counterbalance mechanism acting on the closure panel; and
adjusting a target compensation force to be provided to a motor, of an actuator assembly using the force that negates the effect of the counterbalance mechanism acting on the closure panel.

10. The method as set forth in claim 9, wherein the closure panel is a lift gate, the method further including the steps of:
determining a stop position of the lift gate;
determining whether the lift gate has been stopped at an unbalanced position at which a biasing member coupled to the lift gate does not fully balance of the lift gate;
controlling the motor to hold the lift gate at the stopped position to prevent sag of the lift gate away from the stopped position;
starting a thermal timer; and
controlling the motor to allow the lift gate to move to a steady state position after expiry of a thermal time out.

11. The method as set forth in claim 10, wherein the step of determining the stop position of the lift gate includes determining no motion of the lift gate by a user.

12. The method as set forth in claim 10, wherein the sag of the lift gate occurs in response to the motor not providing additional lifting force of the lift gate in the unbalanced position.

13. The method as set forth in claim 10, wherein the thermal timer is a predetermined time period calculated using an estimated temperature of the motor based on a detected current draw to the motor during a hold operation of the motor and an ambient temperature in which the vehicle is located.

14. The method as set forth in claim 10, wherein the counterbalance mechanism fully supports the lift gate at the steady state position without assistance from the motor.

15. The method as set forth in claim 9, wherein the counterbalance mechanism comprises a counterbalance spring adapted to apply a biasing member force to the closure panel.

16. An actuator system for a closure panel of a vehicle comprising:
an actuator assembly comprising:
an actuator housing,
a power spring at least partially disposed in the actuator housing and adapted to apply a biasing member force to the closure panel, and
a motor disposed in the actuator housing and configured to rotate a motor shaft operably coupled to an extensible member coupled to one of a body and the closure panel for opening or closing the closure panel;
an actuator controller configured to control the motor and output an adjusted force based on the biasing member force to move the closure panel; and
the actuator controller including:
a closed loop current feedback motor control system configured to supply the motor with a drive current,
a haptic control algorithm configured to determine a target torque the motor, controlled by the closed loop current feedback motor control system, applies to the closure panel, and
a drive unit configured to convert the target torque from the haptic control algorithm into a target current for input into the closed loop current feedback motor control system.

17. The actuator system as set forth in claim 16, further including a current sensor configured to detect a sensed current flowing in the motor and communicate the sensed current to the haptic control algorithm.

18. The actuator system as set forth in claim 16, further including an accelerometer configured to sense motion of the closure panel and output an acceleration signal to at least one of the drive unit or the haptic control algorithm.

19. The actuator system as set forth in claim 16, further including closure panel position sensors configured to indicate a position of the closure panel to the drive unit 604.

20. The actuator system as set forth in claim 19, wherein the closure panel position sensors includes at least one closure panel feedback sensor for determining at least one of the position and a speed and an attitude of the closure panel and a further coupled to the motor and configured to provide a motor position of the motor or a speed of the motor.
